(19) United States
(12) Patent Application Publication
(10) Pub. No.: US 2019/0223458 A1
(43) Pub. Date: Jul. 25, 2019

(54) Stable, Packaged, Refrigerated Dough Compositions

(71) Applicant: General Mills, Inc., Minneapolis, MN (US)

(72) Inventors: David J Domingues, Plymouth, MN (US); Craig A Dowd, Eagan, MN (US); Alison Gray, St. Cloud, MN (US); Scott Kackman, New Hope, MN (US); Susan H Messick, Lakeville, MN (US); Christine O'Connor, Rogers, MN (US)

(73) Assignee: General Mills, Inc., Minneapolis, MN (US)

(21) Appl. No.: 16/316,954

(22) PCT Filed: Jul. 12, 2017
(86) PCT No.: PCT/US2017/041652

§ 371 Date: Jan. 10, 2019

Related U.S. Application Data
(63) Continuation of application No. 15/210,569, filed on Jul. 14, 2016, now abandoned.
(60) Provisional application No. 62/472,868, filed on Mar. 17, 2017.
(60) Provisional application No. 62/472,844, filed on Mar. 17, 2017.

(51) Int. Cl. A21D 8/04; A21D 10/02; A21D 2/18; A21D 2/26

(52) U.S. Cl. CPC A21D 8/047; A21D 2/26; A21D 2/186; A21D 10/025

(57) ABSTRACT

Described are raw, yeast leavened dough compositions, packaged products containing the dough, and related methods, wherein the density is stable during refrigerated storage and/or the amount or rate of expansion of the dough during refrigerated storage is controlled.

### FIELD OF THE INVENTION

The invention relates to refrigerator-stable, raw, yeast-containing dough compositions, refrigerated packaged products containing the dough, and related methods.

### BACKGROUND

Packaged raw dough products can provide consumers with a convenient way to enjoy fresh-baked dough products without the need to spend significant time preparing the dough for baking. Typically, packaged raw dough products are either provided as refrigerated products or frozen products. Refrigerated raw dough products generally rely on chemical leavening systems because such leavening systems can be easily controlled to prevent over pressurizing the packaging due to gas release from the dough during shelf life. Even so, many refrigerated dough products are packaged in pressurized cans to prevent the packaging from rupturing during shelf life. However, many consumers are looking for alternatives to both chemically leavened dough and the typical canned dough formats.

### SUMMARY

Provided herein are packaged dough products. In some embodiments, a packaged dough product provided herein includes a yeast-leavened raw dough enclosed in a package. The dough can include 0.1% to 5% by weight yeast (e.g., Mal− yeast), and can have an apparent viscosity of 1000 to about 2000 Brabender Units (BU) and a stable density of no less than 0.950 g/cc to no more than 1.14 g/cc at refrigeration temperatures. A packaged dough product provided herein can additionally have at least one of, or any combination of: a) a flour component in the dough that includes a composite flour in an amount of from about 10% to about 50% by weight of the flour component, the composite flour including at least 95% isolated starch; b) an oil content in the dough of about 2% to about 6% by weight of the dough; or c) gas in a headspace in the package including at least 50% inert gas.

In some embodiments, a packaged dough product can include a yeast-leavened raw dough enclosed in a package, the dough including 0.1% to 5% by weight yeast (e.g., Mal− yeast), and having an apparent viscosity of 1000 to about 2000 Brabender Units (BU) and a stable density of no less than 0.950 g/cc to no more than 1.14 g/cc for at least 14 days at refrigeration temperatures. A raw dough can include at least two of any combination of: a) a flour content in the dough that includes a composite flour in an amount of from about 10% to about 50% by weight of the flour content, the composite flour including at least 95% isolated starch; b) an oil content in the dough of about 2% to about 6% by weight of the dough; or c) gas in a headspace in the package including at least 50% inert gas.

In some embodiments, an isolated starch in a composite flour can include from 30% to 70% isolated potato starch. In some embodiments, a composite flour can include a protein concentrate or proteidisolate.

In some embodiments, a flour component can have an amylase activity of 36 Beta amyl-3 U/g of the flour component or less. In some embodiments, a flour component can have a starch content that contains less than 5% damaged starch by weight of the starch content.

In some embodiments, a dough can include an ethanol ingredient in an amount of about 0.8% to about 1.4% by weight of the dough.

In some embodiments, a package can be non-pressurized. In some embodiments, a package can be vented. In some embodiments, a package can be a pouch.

In some embodiments, a packaged dough product can have a headspace gas that contains essentially all inert gas.

In some embodiments, a packaged dough product can have a shelf life at refrigerated temperatures of at least 30 days. In some embodiments, the density of a dough in a packaged dough product can be stable over at least 30 days at refrigeration temperatures.

In some embodiments, a dough in a packaged dough product provided herein can require no proofing time between removal from the package and before cooking.

In some embodiments, a dough in a packaged dough product can be formed into a sheet from about 1 mm to about 6 mm thick. In some embodiments, a dough in a packaged dough product can be sheet rolled into a scroll configuration. In some embodiments, a dough in a packaged dough product can be a raw pizza crust. In some embodiments, a dough in a packaged dough product can be formed into a raw bread loaf.

Methods of making a packaged dough product are also provided herein. In some embodiments, a method of making a packaged dough product includes combining dough ingredients to make a raw dough, shaping the raw dough into pieces, and packaging the shaped raw dough pieces into a package to produce the packaged dough product, where the raw dough pieces have a stable density of no less than 0.950 g/cc to no more than 1.14 g/cc at refrigeration temperatures. A raw dough used in a method of making a packaged dough product herein can include 0.1% to 5% by weight yeast (e.g., Mal− yeast) and can have an apparent viscosity of 1000 to about 2000 Brabender Units (BU), where the raw dough can include one or both of: a) a flour component that includes a composite flour in an amount of from about 10% to about 50% by weight of the flour component, the composite flour including at least 95% isolated starch; or an oil content of about 2% to about 6% by weight of the raw dough.

In some embodiments, a method of making a packaged dough product can include combining dough ingredients to make a raw dough, shaping the raw dough into pieces, and packaging the shaped raw dough pieces into a package to produce the packaged dough product, the raw dough pieces having a stable density of no less than 0.950 g/cc to no more than 1.14 g/cc at refrigeration temperatures. A raw dough used in a method of making a packaged dough product herein can include 0.1% to 5% by weight yeast (e.g., Mal− yeast), and can have an apparent viscosity of 1000 to about 2000 Brabender Units (BU), where a flour component in the raw dough can include a composite flour in an amount of from about 10% to about 50% by weight of the flour component, the composite flour including at least 95% isolated starch, and/or the raw dough can include an oil content of about 2% to about 6% by weight of the raw dough.

In some embodiments, a method of making a packaged dough product can include a step of replacing air in a headspace of the package with at least 50% inert gas.

In some embodiments, a method of making a packaged dough product, the method includes combining dough ingredients to make a raw dough, shaping the raw dough into pieces, packaging the shaped raw dough into a package, and replacing air in a headspace of the package with at least 50% inert gas to produce the packaged dough product, the raw dough pieces having a stable density of no less than 0.950 g/cc to no more than 1.14 g/cc at refrigeration temperatures. A raw dough used in a method of making a packaged dough product herein can include 0.1% to 5% by weight yeast (e.g., Mal− yeast) and can have an apparent viscosity of 1000 to about 2000 Brabender Units (BU).

In some embodiments, a method of making a packaged dough product includes combining dough ingredients to make a raw dough, shaping the raw dough into pieces, packaging the shaped raw dough pieces into a package, and replacing air in a headspace of the package with at least 50% inert gas to produce the packaged dough product, the raw dough pieces having a stable density of no less than 0.950 g/cc to no more than 1.14 g/cc at refrigeration temperatures. A raw dough used in a method of making a packaged dough product herein can include 0.1% to 5% by weight yeast (e.g., Mal− yeast), and can have an apparent viscosity of 1000 to about 2000 Brabender Units (BU), where the dough has one or both of: a) a flour component that includes a composite flour in an amount of from about 10% to about 50% by weight of the flour component, the composite flour including at least 95% isolated starch; orb) an oil content of about 2% to about 6% by weight of the raw dough.

In any method of making a packaged dough product, shaped raw dough pieces can proof in the package.

In some embodiments of a method provided herein, an isolated starch in a composite flour includes from 30% to 70% isolated potato starch. In some embodiments of a method provided herein, a composite flour can include a protein concentrate or protein isolate.

In some embodiments of a method provided herein, a flour component in a raw dough can have an amylase activity of 36 Beta amyl-3 U/g of the flour component or less. In some embodiments of a method provided herein, a flour component in a raw dough can have a starch content that contains less than 5% damaged starch by weight of the starch content.

In some embodiments of a method provided herein, a raw dough can include an ethanol ingredient in an amount of about 0.8% to about 1.4% by weight of the raw dough.

In some embodiments of a method provided herein, a package can be non-pressurized. In some embodiments of a method provided herein, a package can be vented. In some embodiments of a method provided herein, a package can have a headspace that has essentially all inert gas. In some embodiments of a method provided herein, a package can be a pouch.

In some embodiments of a method provided herein, a packaged dough product can have a shelf life at refrigerated temperatures of at least 30 days. In some embodiments of a method provided herein, a packaged dough product can have a stable density over at least 30 days at refrigeration temperatures.

In some embodiments of a method provided herein, a raw dough can require no proofing time between removal from the package and before cooking.

In some embodiments of a method provided herein, a raw dough can be formed into a sheet from about 1 mm to about 6 mm thick. In some embodiments of a method provided herein, a raw dough sheet can be rolled into a scroll configuration. In some embodiments of a method provided herein, a raw dough can be a pizza crust. In some embodiments of a method provided herein, a raw dough can be a bread loaf.

### BRIEF DESCRIPTION OF THE FIGURES

FIG. 1 is a graph of amylase activity for a range of dough compositions.

FIG. 2 is a plot of experimental data relating to carbon dioxide release over a range of dough compositions.

FIG. 3 is a plot of experimental data relating to carbon dioxide release rate over a range of dough compositions.

FIG. 4 is a plot of experimental data relating to carbon dioxide release rate over a range of dough compositions.

FIG. 5 is a plot of experimental data relating to specific volume of a dough over a range of carbon dioxide release rates.

FIG. 6 is a plot of experimental data relating to dough specific volume versus time for doughs having different carbon dioxide release rates.

FIG. 7 is a plot of experimental data relating to dough specific volume versus carbon dioxide release rate, over different refrigeration periods.

FIG. 8 is a plot of experimental data relating to carbon dioxide release rate over a range of dough compositions, and MAL− yeast content.

FIG. 9 is a plot of experimental data relating to dough density over time, comparing the effects of flour components and gluten content.

FIG. 10 is a plot of experimental data relating to carbon dioxide release over time, comparing the effects of flour components and gluten content.

FIG. 11 is a plot of experimental data relating dough density over time, comparing the effects of oil content and gluten content.

FIG. 12 is a plot of experimental data relating dough density over time, comparing the effects of oil content and gluten content.

FIG. 13 is a plot of experimental data relating to dough density over time, comparing the effects of headspace flush composition.

FIG. 14 is a plot of experimental data relating carbon dioxide headspace over time, comparing the effects of headspace flush composition.

FIG. 15 shows packaged dough compositions that have been stored in rolled form at refrigerated conditions, then unrolled. 15A shows a dough that had a headspace flushed with 100% nitrogen. 15B shows a dough that had a headspace flushed with 50% nitrogen and 50% carbon dioxide. 15C shows a dough that had a headspace flushed with 100% carbon dioxide.

FIG. 16 Figure shows concentrations of carbon dioxide in headspaces of a packaged dough products, some containing ethanol.

### DETAILED DESCRIPTION

While yeast leavened doughs can be found as frozen products, these products generally require thawing time and leavening time before baking. This additional preparation time before using a raw dough is inconvenient to consumers that desire time saving products that meet their needs. Providing yeast leavened dough in a refrigerator-stable format, however, has proven difficult because yeast activity is not entirely halted at refrigeration temperatures. As a result, unwanted dough expansion and/or gas release into the packaging during storage can result in distortion of the packaging, such as bulging or rupturing of the packaging. Distortion can not only cause consumers to find the product undesirable, and reduce the aesthetics of the package, but ruptures in the packaging can cause contamination of raw dough, which can cause illness upon consumption of products made with the dough. Even rigid and/or pressurized packaging can be susceptible to distortion if there is sufficient yeast activity. Previous attempts at making a refrigerator stable, yeast-leavened dough were either unsuccessful, or had a limited shelf life (e.g., less than 20 days).

To meet the desires of consumers who would prefer convenient dough options without the use of chemical leavening systems, it was discovered that a combination of dough characteristics could provide a packaged, yeast-leavened dough that is stable at refrigeration temperatures (e.g., above freezing to about 10° C.) for extended periods (e.g., at least 14 days, at least 30 days, or least 45 days) without significant packaging distortion. A packaged dough provided herein is formulated to maintain a stable density at refrigeration temperatures. The inventive products described herein surprisingly achieve extended, refrigerated shelf life stability, even in a flexible packaging, without compromising the expected characteristics of a cooked dough-based product made from a fresh, yeast-leavened dough.

As used herein, the term “stable density” refers to a density that does not vary more than 20% over at least 14 days (e.g., at least 20 days, at least 30 days, or at least 45 days) following packaging. For example, a stable density can range from 0.900 g/cc to 1.10 g/cc over the 14 days. A stable density can alternatively be described as having a particular density±10% over the designated time frame. Under this alternative description, the example above with a stable density can be described as having a density of 1.00 g/cc±10%. It is to be understood that the level of density variation can be less than 20% (e.g., less than 15%, less than 10%, or less than 5%), or alternatively, a particular density±less than 10% (e.g., ±less than 5%, or ±3%), and still be considered a stable density.

In some embodiments, a stable density can be further limited to a particular density range, which the density does not exceed during the designated time frame. For example, a stable density can be limited to a range of no less than 0.950 g/cc to no more than 1.14 g/cc over the designated time. In this example, a stable density is a density that both does not vary more than 20% over the designated time frame and does not go below 0.950 g/cc nor go above 1.14 g/cc over the designated time frame. In another example, a stable density can be limited to a range of no less than 1.00 g/cc to no more than 1.12 g/cc over the designated time. In this example, a stable density is a density that both does not vary more than 20% over the designated time frame and does not go below 1.00 g/cc nor go above 1.12 g/cc over the designated time frame.

In some embodiments, a stable density in a dough can also be observed as a stable dough volume. As used herein, the term “stable dough volume” refers to a dough that does not vary more than 20% (e.g., no more than 10%, or no more than 5%) over at least 14 days (e.g., at least 20 days, at least 30 days, or at least 45 days). For example, a stable dough volume can increase by no more than 20% or decrease no more than 20% over at least 14 days at refrigeration temperatures. In some embodiments, a dough provided herein can expand no more than 0.2 cubic centimeters/gram dough (e.g., no more than 0.1 or 0.05 cubic centimeters/gram dough) over at least 14 days at refrigeration temperatures following packaging.

In order to maintain a stable density, a packaged dough provided herein can have a relatively high apparent viscosity, along with one or more additional features, selected from: 1) a substrate-limited yeast (e.g., a maltose negative yeast), 2) a flour content in the dough that includes a composite flour; 3) an oil content in the dough; and 4) gas in a headspace in the packaging that includes an inert gas. Without being bound to theory, it is believed that a relatively high apparent viscosity in a packaged dough provided herein can help provide a dough structure resistant to volume expansion, and therefore support a stable density under controlled carbon dioxide content in the dough. Carbon dioxide content in dough can be controlled (e.g., by controlling the rate of production by yeast, by controlling the amount produced by yeast, by controlling the amount released from the dough, or controlling the amount absorbed by the dough) using one or more of the additional features. It is to be understood that features useful for controlling carbon dioxide content in dough can be used individually to arrive at a packaged dough having a stable density at refrigeration temperatures, or can be used in any combination.

Apparent Viscosity

Apparent viscosity is a measure of dough rheology, measured in Brabender Units (BU), as measured using an Extensiometer. Standard tests for measuring apparent viscosity of a dough are known, including test procedure 54-22.01, approved by the American Association of Cereal Chemists, Inc. A dough provided herein can have an apparent viscosity of at least 1000 BU (e.g., at least 1100 BU, or at least 1200 BU, or from 1000 BU to 2000 BU, or from 1200 BU to 1800 BU, or about 1300 BU to about 1600 BU). A dough having a higher apparent viscosity is relatively more stiff and less flexible compared to a dough having a lower apparent viscosity. It has been discovered that a dough composition that has an apparent viscosity of a least 1000 BU can exhibit a reduced amount of expansion in volume during refrigerated storage in package that is at about atmospheric pressure.

Surprisingly, even though a dough provided herein has a relatively high apparent viscosity as compared to typical Boughs, which range from about 800 BU to 1000 BU regardless of leavening type, a dough provided herein does not produce a cooked (e.g., baked or fried) dough product that is unpleasantly hard or stiff.

In some cases, an apparent viscosity of greater than about 1600 BU can begin to negatively affect the handleability of a dough and/or texture of a cooked dough product. While some changes in handleability and/or cooked dough product may be acceptable, it is preferred that the apparent viscosity of a dough be no more than 1600. In some embodiments, apparent viscosity of a dough provided herein remains stable (e.g., within ±10%, or within ±5%) throughout a shelf life at refrigerated temperatures for at least 14 days (e.g., at least 20 days, at least 30 days, or at least 45 days).

Aside from apparent viscosity, a dough provided herein can have additional mechanical properties, such as extensibility and maximum resistance during extension (Rmax), that are measured using an Extensiometer. In some embodiments, a dough provided herein can have an extensibility of at least 60 millimeters (mm) (e.g., at least 70, 80, or 90 mm). As used in the bread and dough arts, extensibility of a dough is a measure, in length, of how far a dough sample can be extended before breaking. In some embodiments, a dough provided herein can have an Rmax of at least 1000 Brabender Units (e.g., at least 1100 BU). As used in the dough and bread arts, maximum resistance (Rmax) during extension is a measure of force that can be presented in Brabender Units (BU), or Newton-meters. Standard tests for measuring Rmax and extensibility of a dough are known, including test procedure 54-10.01, approved by the American Association of Cereal Chemists, Inc.

Apparent viscosity of a dough provided herein can be adjusted by adjusting ingredient content, including for example, the amount of water in the dough; the amounts and types of flour, starch, and protein (e.g., gluten) in the dough; the relative amount of flour (including all sources of protein and starch) to water in the dough, i.e., the flour to water ratio; the presence of other ingredients that may affect the behavior of water (e.g., ethanol); the presence of salt (e.g., sodium chloride); the amount, types, and level of development of proteins in the dough; etc. Generally, lower water content and/or water activity, higher flour to water ratios, higher protein content, and greater protein development (e.g., gluten matrix) contribute to a higher apparent viscosity, while the converse contribute to a lower apparent viscosity.

In some embodiments, the amount of water in a dough provided herein can range from about 30 to 40 weight percent (e.g., from 30 to 37 weight percent, or 31 to 35 weight percent) based on total weight dough composition. Amounts of water outside of these preferred ranges could also be useful in a dough of the present description, depending, for example, on how other ingredients present in the dough affect the behavior of the water, and the types of protein or flour present in the dough.

In some embodiments, the amount of flour component in a dough provided herein can range from about 30 to about 70 weight percent (e.g., from about 40 to about 60 weight percent, or from about 45 to about 55 weight percent) based on total weight dough composition. A flour component in a dough provided herein includes all sources of flour, protein, and starch.

In some embodiments, a dough provided herein can be formulated to have a flour to water ratio ranging from about 1.55:1 to 2:1 (e.g., from 1.6:1 to 1.9:1, or from about 1.7:1 to about 1.9:1). As used herein flour to water ratio refers to the ratio of the amount of flour component to the amount of water from all sources (e.g., added water and moisture content of other dough ingredients, such as eggs, ice, milk, and the like).

Yeast

A dough provided herein is yeast-leavened. As used herein, the term “yeast-leavened” refers to a dough composition that is leavened substantially or primarily by the production of metabolites of yeast, including carbon dioxide produced by the yeast. The carbon dioxide can be produced at any time that the yeast resides in the dough composition, such as during preparation of the dough, during storage of the dough (e.g., during refrigerated storage in a package), after removal of the dough from a package, or just prior to or during cooking the dough. A dough will be referred to as “yeast-leavened” if it meets this criterion, regardless of the state of leavening or expansion of the dough. A dough provided herein does not require and can preferably exclude the presence of chemical leaveners that produce carbon dioxide before or during cooking.

As used herein, a yeast-leavened dough includes yeast in an amount sufficient to impart flavor and/or aroma qualities expected in yeast-leavened dough-based foods, including flavors imparted by compounds such as carbonyls, aldehydes, and ketones. Suitable amounts of yeast in a dough provided herein can range from about 0.05% to about 5% (e.g., from about 0.1% to about 2.5%, or from about 0.5% to about 1.5%) on a dry, active yeast basis, by weight of the dough.

Any yeast suitable for making leavened dough can be used in a dough provided herein, particularly if other dough and/or packaging features are included to control carbon dioxide production, though a substrate-limited yeast is preferred. As used herein, the term “substrate-limited yeast” refers to yeast that are incapable of metabolizing certain types of sugars, such as maltose. One such strain of yeast is incapable of metabolizing maltose, and is referred to as “maltose-negative” (or MAL−) yeast.

Maltose-negative yeasts are known and commercially available. Referred to as “maltose-negative,” or just “MAL−,” these yeasts do not metabolize maltose, but are usually capable of metabolizing other types of sugars such as fructosans (e.g., sucrose, dextrose, and fructose). A number of yeasts that ferment sucrose but not maltose (“SUC+/MAL−”) are commercially available, including the following strains of Saccharomyces cerevisiae: DZ (CBS 109.90), DS 10638 (CBS 110.90), DS 16887 (CBS 111.90) V 79 (CBS 7045), and V 372 (CBS 7437). An example of MAL− yeast is a yeast product available commercially under the trade name FLEXFERM, from Lallemand, Inc. See also U.S. Pat. Nos. 5,385,742; 5,571,544; 5,540,940; 5,744,330, the entirety of each of these being incorporated herein by reference.

A substrate-limited yeast can be effective to control the amount of carbon dioxide produced in a dough composition, especially during preparation or during storage, because the yeast is less active due to its inability to metabolize certain types of sugars. In some embodiments, a substrate-limited yeast can be included in a dough formulation along with a controlled amount and/or types of sugars (e.g., by limiting the amount of damaged starch and/or limiting the amount of carbohydrase enzymes, such as amylase, in dough) to further reduce or limit the amount of carbon dioxide that is produced by the yeast. For example, sugar availability to yeast in dough can be controlled by use of a composite flour in a flour component and/or by use of a flour component with reduced damaged starch content and/or carbohydrase enzyme activity.

The yeast can be part of a yeast composition that may be in any one of various forms, such as cream yeast, compressed yeast or fresh yeast, and dried yeast, these forms having different amounts of water present. Dried yeast is available as active dry yeast (ADY) and as instant dry yeast (IDY) having moisture contents of 6 to 8 percent and 3 to 6 percent, respectively.

Flour Component

A flour component suitable for use in a dough provided herein can include any flour. Various types and variations of flour are known, for example based on being prepared from different parts of a flour kernel (e.g., wheat kernel), or based on different types of flour kernels (e.g., wheat kernels) used to produce a flour (which can have an effect on the relative amounts of different components present in the flour, e.g., starch and protein). A wheat kernel contains portions referred to as an endosperm, germ, and bran. The endosperm contains high levels of protein and starch. The wheat germ is rich in protein, fat, and vitamins. And the bran portion is high in fiber. White flour is made from just the endosperm predominantly (optionally with some minor or incidental inclusion of other components). Brown flour additionally includes germ and bran. Whole grain flour is prepared from the entire grain, including the bran, endosperm, and germ.

A major, generally primary, constituent of flour is starch. The term “starch” is used in the present description in a manner consistent with its well understood and conventional meaning in the chemical and food arts. Consistent therewith, starch is a nutrient carbohydrate, e.g. of glucose (C₆H₁₀O₅)ₙ, that is found in and can be separated, in concentrated form, from biomass such as seeds, fruits, tubers, roots, and stem pith, of plants, notably in corn, potatoes, wheat, tapioca, legumes, and rice. Starch is a collection of polymeric carbohydrate molecules including a form referred to as amylose, which is a straight-chain polymer, and another form referred to as amylopectin, which is a branched-chain polymer molecule. Starch molecules are predominantly in the form of “particles” or “granules” of tightly packed collections of the starch molecules, but lower molecular weight fragments may (i.e., “damaged starch”) be also present in a flour, separate from the starch granules. In some embodiments, the amount of damaged starch in a flour can be less than 5% (e.g., less than 3%, less than 2%, or less than 1%) based on the total amount of starch in the flour.

Flour for use in flour component of a dough as described can be any conventional flour (e.g., hard winter wheat flour, soft spring wheat flour, oat flour, and the like, or blends thereof), an analog thereof, or any flour having a composition that is consistent with the present description, such as a heat-treated flour or “fancy patent flour” adapted to contain relatively low amounts of active enzyme, damaged starch, or both. Examples include commercially available wheat flours such as those referred to as “all-purpose” flour (“plain” flour), “bread” flour (“strong” flour), whole wheat flour, and the like. Such a flour can include major amounts of starch and protein, and lesser amounts of fat, sugar, vitamins, minerals, and moisture. Typical ranges of certain flour components can be: from 65 to 75 weight percent starch; from about 8 to 15 weight percent protein (e.g., gluten); less than 2 weight percent fat; and small amounts of sugar, fiber, enzymes, vitamins, and minerals.

In some embodiments, a flour component can include a composite flour. As used herein, a “composite flour” includes an isolated starch and, optionally, a protein concentrate or protein isolate. An isolated starch in a composite flour includes a high concentration of starch, e.g., at least 70, 80, 90, 95, 98, or 99 weight percent starch based on total weight solids in the starch ingredient. An isolated starch can be mostly in granule form but can also include a low or minor amount of damaged starch, e.g., less than 5, 3, 2, or 1 weight percent damaged starch based on total weight of starch isolated starch. Isolated starch can be derived from any plant or other starch source, such as from wheat, corn, potato, rice, tapioca, oat, barley, millet, bananas, sorghum, sweet potatoes, rye, as well as other cereals, legumes, and vegetables, or combinations thereof. A composite flour can include an isolated starch in an amount of at least 60% (e.g., at least 70%, at least 90%, or at least 95%) by weight of the composite flour.

In some embodiments, a starch included in a composite flour includes a potato starch in an amount of about 30% to about 70% (e.g., from about 40% to about 60%, or about 50%) of the starch content in the composite flour, with the remaining starch being a non-potato starch (e.g., wheat starch, corn starch, tapioca starch, and the like). Such a combination of potato starch and non-potato starch can provide desired handling and aesthetic characteristics to a dough. For example, potato starch can reduce stickiness of a dough, while non-potato starch can reduce visible cracking on the surface of the dough.

Isolated starch in a composite flour can help maintain a stable density in a dough. Isolated starch in a composite flour can also help slow the rate of carbon dioxide release from a dough. Without being bound by theory, it is believed that isolated starch reduces the availability of sugars available to yeast in a dough, and thus slow carbon dioxide production by the yeast, by substituting part, or all, of the starch in a flour component with mostly undamaged starch (e.g., less than 5%, or less than 3%, or less than 1% damaged starch by weight of the starch content in the isolated starch).

A concentrated or isolated protein in a composite flour includes a high concentration of protein, e.g., at least 70, 80, 90, 95, 98, or 99 weight percent protein based on total weight solids in the concentrated or isolated protein. The concentrated or isolated protein may be derived from any plant or other protein source, such as from dairy (e.g., whey), soy, wheat (e.g., vital wheat gluten), fish, eggs, poultry, or legume, grain, or animal sources. Protein content in a composite flour can be 30% or less (e.g., less than 20%, less than 10%, or less than 5%) of the composite flour.

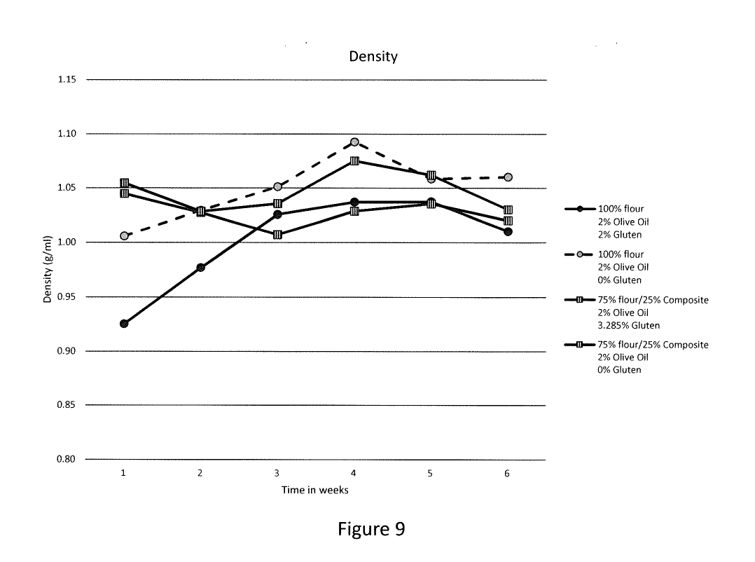

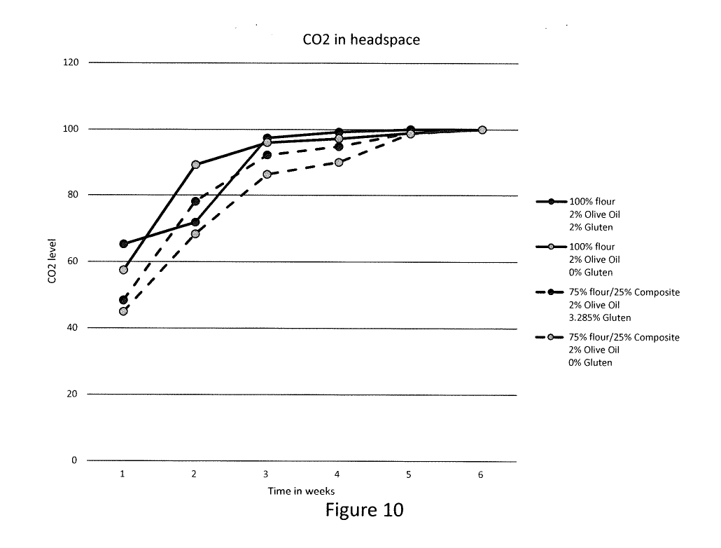

Although a concentrated or isolated protein need not be included in a composite flour, it can be used to simulate protein content in flour, or to provide a desired protein content in a packaged dough. In some embodiments, a concentrated or isolated protein can help produce a desired dough functionality. For example, a vital wheat gluten can be included in a composite flour to provide functionality (e.g., texture, viscosity, extensibility) normally provided by gluten in a wheat flour. In addition, protein in a composite flour can help stabilize density over time. For example, inclusion of vital wheat gluten in a composite flour can increase carbon dioxide release from a dough (see, FIG. 10), and thus increase density during storage (see, FIG. 9), so the amount of protein in a composite flour can be adjusted to achieve a stable density.

Up to the entirety (i.e., up to 100%) of a flour component can be a composite flour. However, where included in a flour component, a more preferred amount of composite flour is from about 15% to about 50% (e.g., from about 20% to about 30%, or about 25%) of the flour component. In some embodiments, a flour component contains no composite flour.

In some embodiments, a flour, composite flour, and/or flour component can exhibit a reduced level of active amylase enzyme (e.g., have a beta amylase activity of not greater than 36 Beta amyl-3 U/g, not greater than 28 Beta amyl-3 U/g, or not greater than 19 Beta amyl-3 U/g). A reduced level of active amylase enzyme can be measured or quantified by known methods, e.g., assay methods (tested at room temperature), examples of which are well known or commercially available. For example, a level of active amylase enzymes of a dough, flour, flour component, protein ingredient, starch ingredient, etc., can be measured or quantified by known methods, such as assay methods, one commercially available example being the beta-Amylase (Betamyl® Method; K-BETA3) Procedure for ChemWell® Auto Analyser, as described at https://secure.megazyme.com/files/Data_Booklets/K-BETA3_D-CHEMT.pdf. In example embodiments, a dough as described can have a beta amylase activity, (measured within 2 hours after the final step of preparing the dough, and at room temperature, e.g., 70 degrees Fahrenheit) of not greater than 19 Beta amyl-3 Units per gram (U/g), e.g., not greater than 15 Beta amyl-3 U/g, or not greater than 10 Beta amyl-3 U/g. Examples of flour that is prepared to contain a relatively low amount of active enzyme are described in U.S. Pat. No. 7,258,888; and in United States Patent Publication Number 2007/0259091, the entireties of each of these documents being incorporated herein by reference.

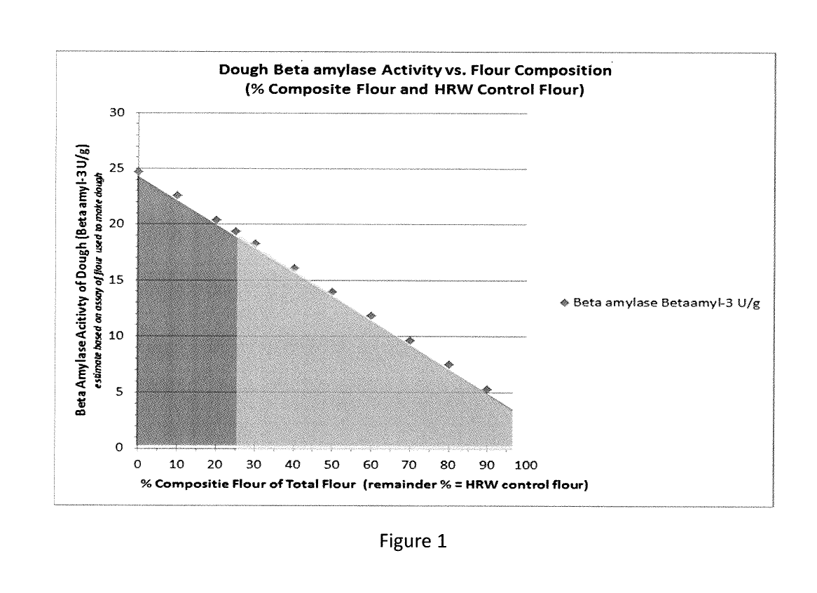

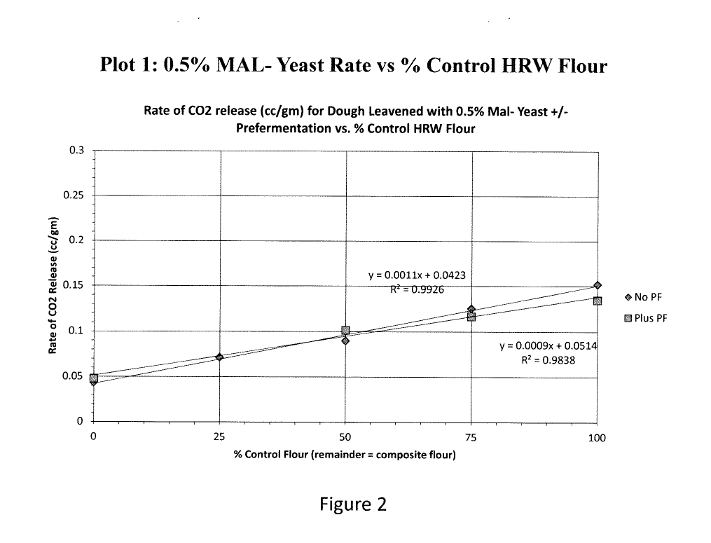

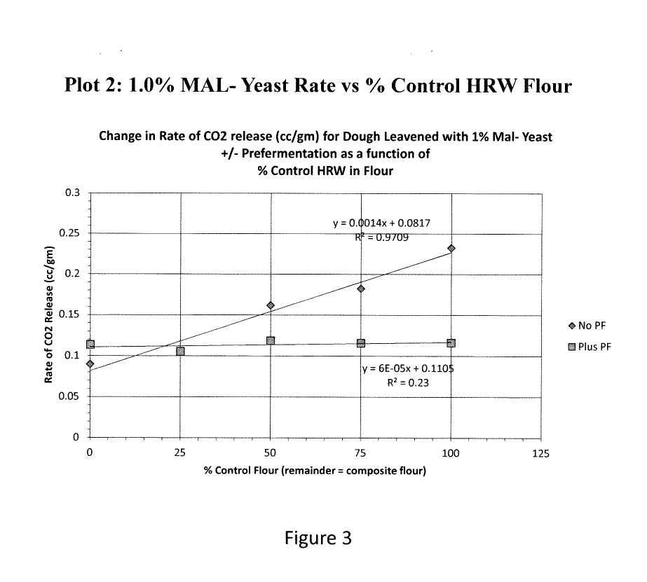

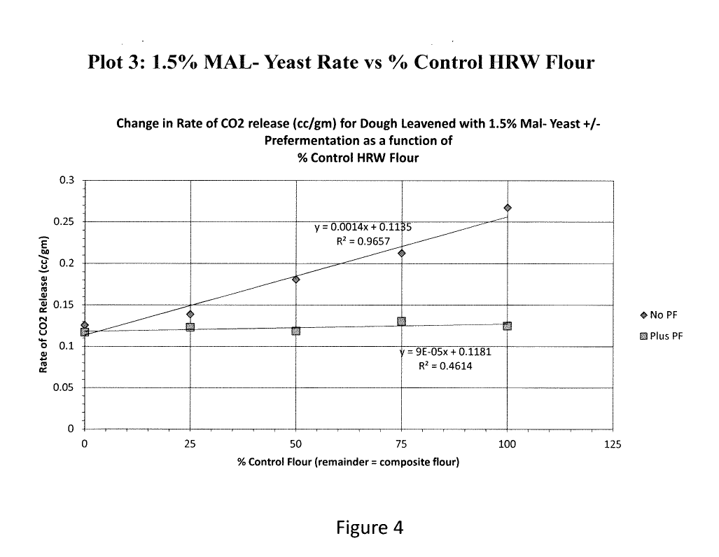

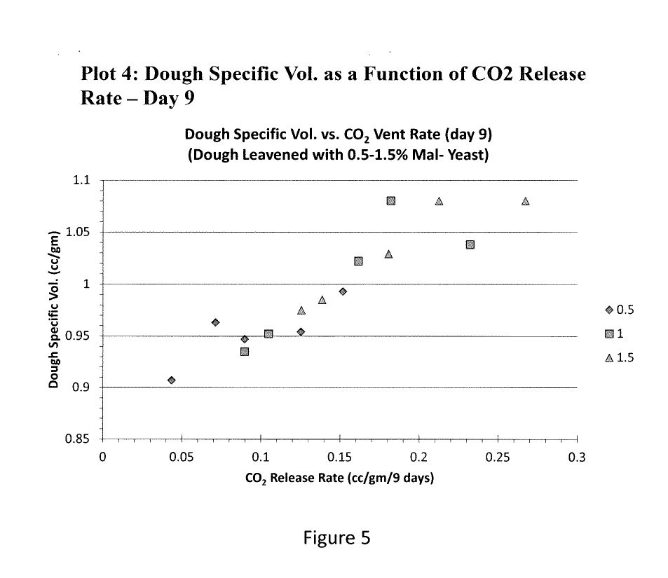

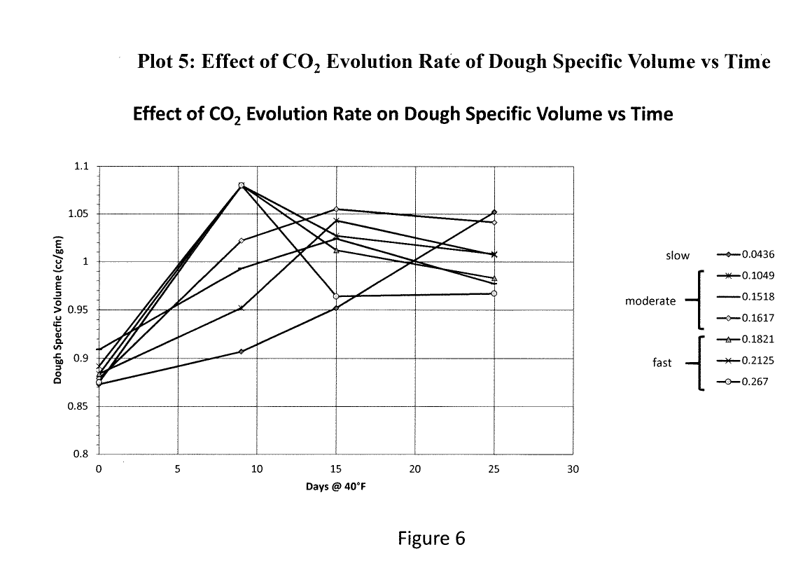

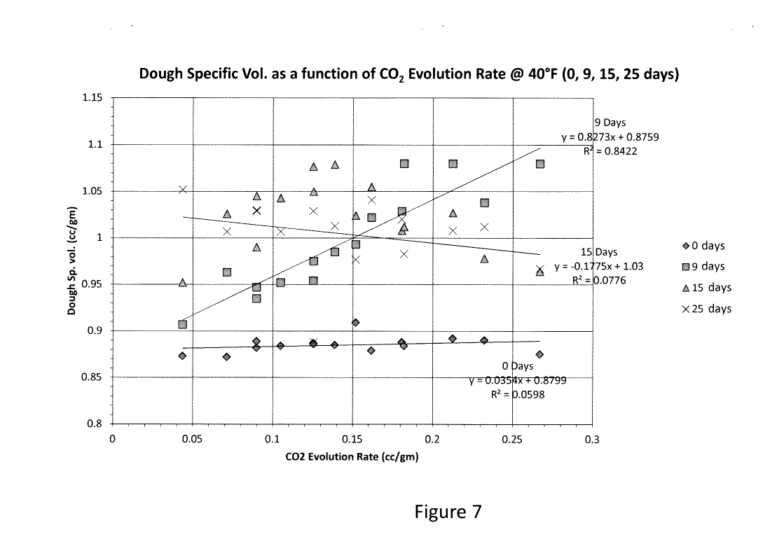

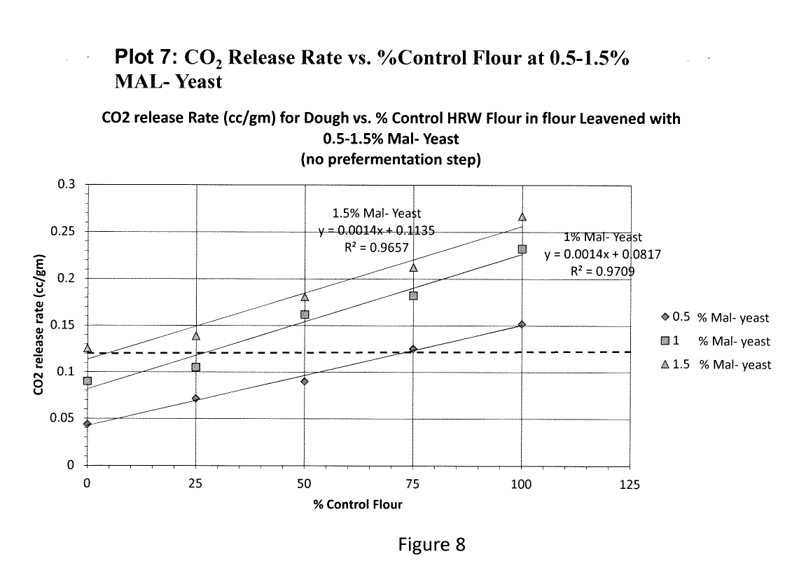

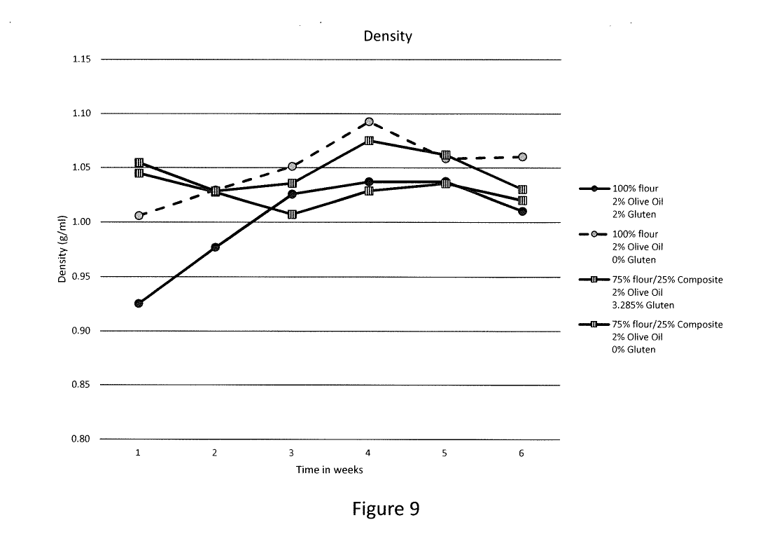

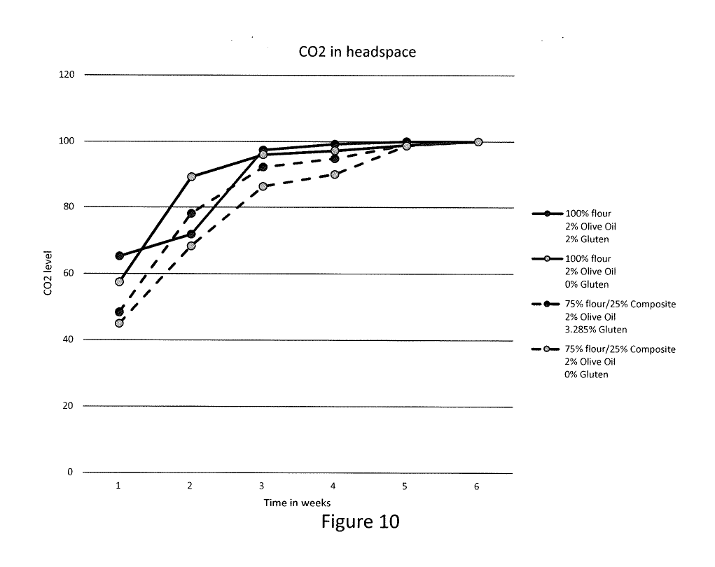

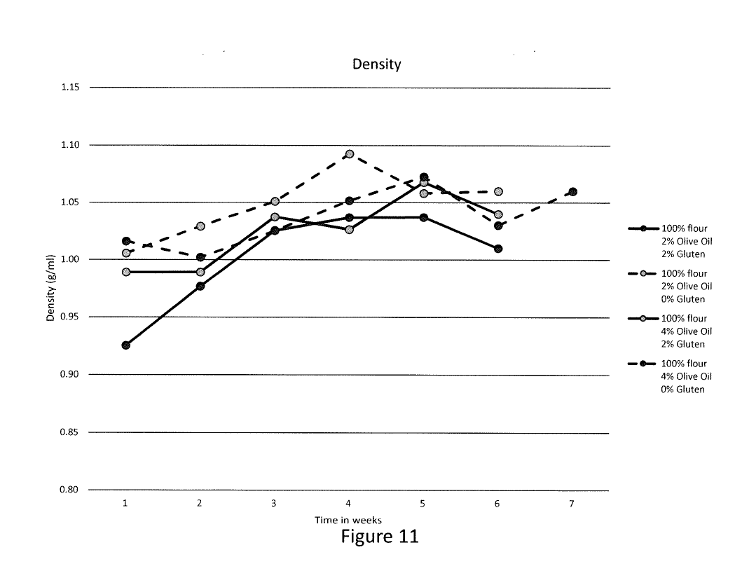

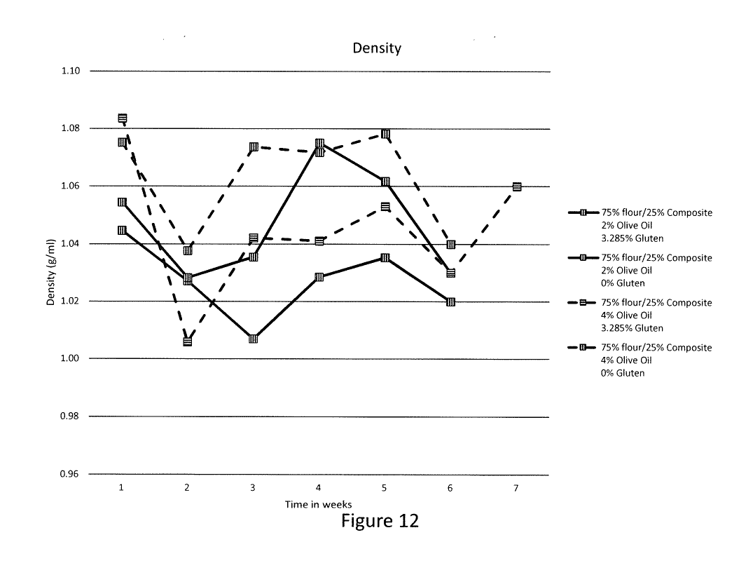

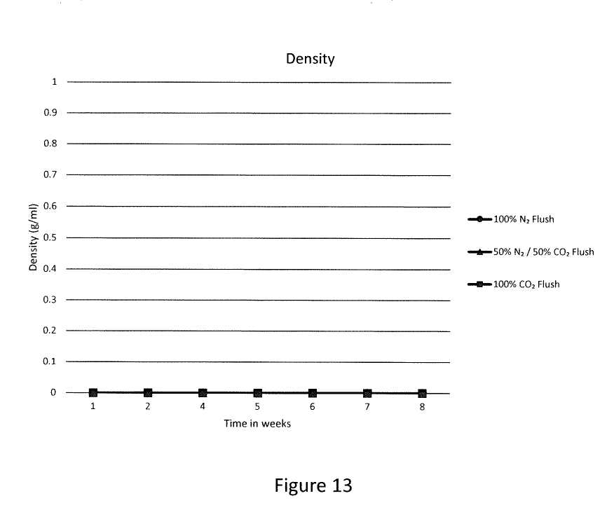

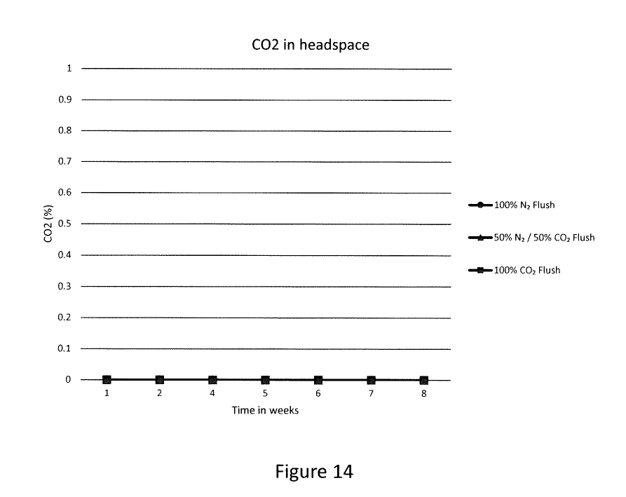

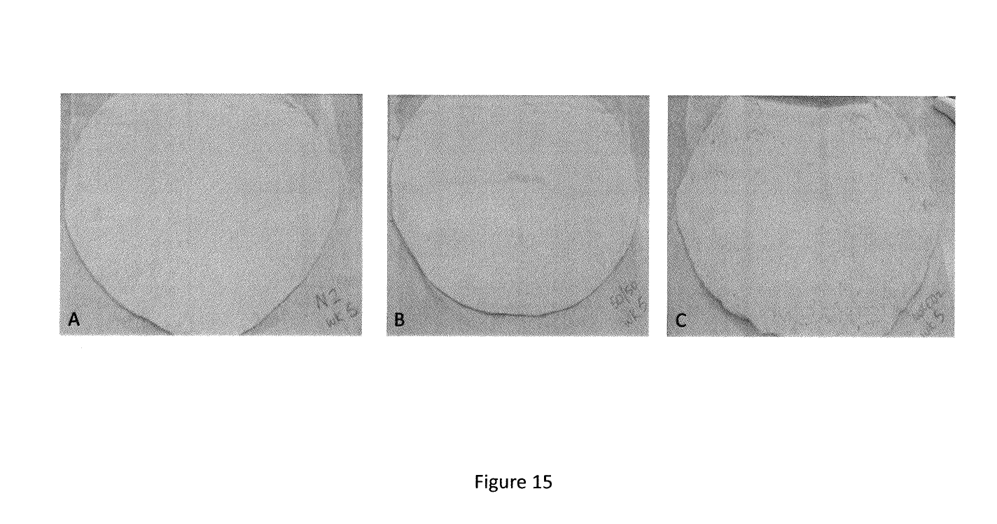

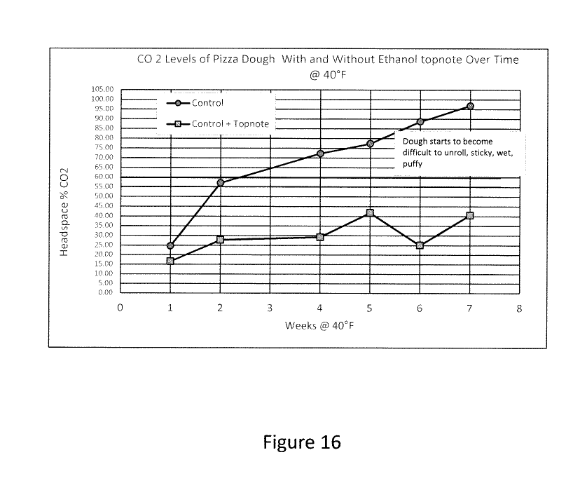

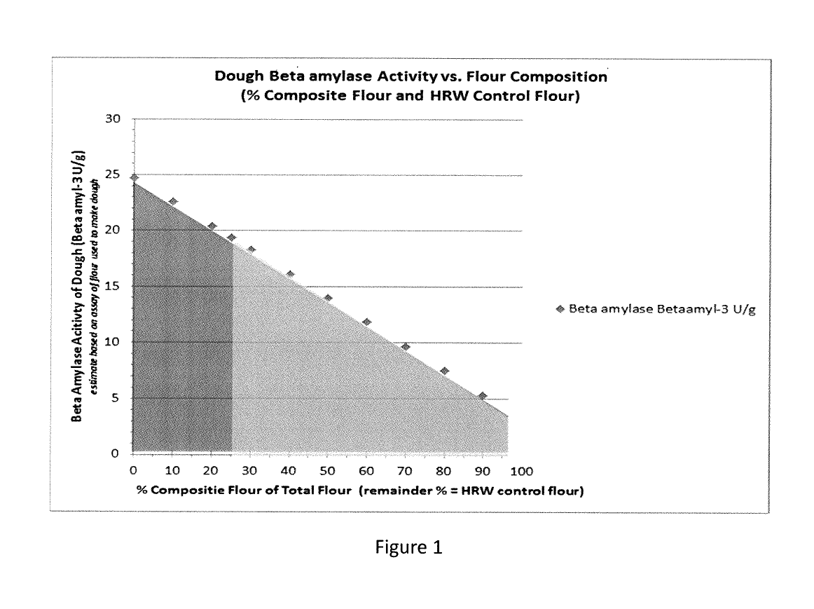

As illustrated, in FIG. 1, amylase activity of a dough can be adjusted by the inclusion of a composite flour in the flour component. Amylase activity in a dough containing hard red winter wheat flour (HRW) can be reduced with increasing amounts of composite flour. Example doughs of the graph of FIG. 1 (shown with light shading) also exhibited particularly useful shelf life stability, e.g., the doughs produced a sufficiently low level of carbon dioxide to allow for the dough to be stored at a refrigerated condition (optionally in a package) without exhibiting an undesired change (increase) in dough volume, or an undesirably high amount of carbon dioxide production, as described herein. Doughs that contain a flour component having less than 20 or 25 weight percent composite flour can also be useful in a dough product as described, for example when used with other features of a dough composition or dough product that allow for controlled density of the dough during refrigerated storage, e.g., substrate-limited yeast, a reduced amount of damaged starch in flour, mechanical properties (apparent viscosity, Rmax, extensibility) of the dough, controlled atmosphere in a package headspace, or both.

Oil Content

In some embodiments, an oil can be included in a dough provided herein. As used herein, the term “oil” refers to an edible fat that is liquid at room temperature. Suitable oils for inclusion in a dough provided herein include any edible oil, such as soybean oil, olive oil, corn oil, canola oil, sunflower oil, and the like, or combinations thereof. An oil content of from about 2% to about 6% (e.g., from about 2% to about 4%) can contribute to a controlled release of carbon dioxide from a dough.

Package Headspace

In packaging that has a headspace between a dough and the package, inclusion of an inert gas in the headspace can help control carbon dioxide absorption into the dough from the headspace. In some embodiments, air in the headspace can be replaced (i.e., flushed) with gas that contains at least 50% (e.g., at least 75%, or at least 98%) inert gas (e.g., nitrogen or argon) in order to further extend shelf life of the packaged dough product. During shelf life of a packaged dough product, inert gas content in a headspace of a package may be reduced as carbon dioxide is released from the dough. Thus, even if a headspace had been flushed with a gas that is essentially all (at least 99%) inert gas upon packaging, the headspace may contain less than 99% inert gas at 14 days following packaging, and even less over the course of a shelf life greater than 14 days.

Other Carbon Dioxide Controlling Features

In some embodiments, ethanol included in a dough provided herein can contribute to maintaining a stable density by reducing carbon dioxide release from the dough. In some embodiments, ethanol can also function by reducing the amount of carbon dioxide production and/or the rate of carbon dioxide production of yeast in a dough. Ethanol can be included in a dough in an amount of from about 0.7 to about 1.1 moles ethanol per liter water (e.g., from 0.75 to 1.0, or from 0.8 to 0.95 moles ethanol per liter water) in the dough composition. In some embodiments, ethanol can be included in an amount ranging from 0.8 to 1.4, e.g., from 1.0 to 1.2 weight percent ethanol based on total weight of a dough composition.

In addition, packaging characteristics described herein can also contribute to a yeast leavened dough that has a stable density at refrigeration temperatures.

In some embodiments, a package used to package a dough can be non-pressurized. As used herein, “non-pressurized” refers to a package that is not positively pressurized (i.e., having pressure at, or less than, about atmospheric pressure). In some embodiments, a non-pressurized package can have a headspace at about atmospheric pressure (e.g., 1 atm±0.2 atm (absolute)). A non-pressurized package, particularly with a headspace that includes an inert gas, can contribute to control of carbon dioxide absorption by a dough in the package.

In some embodiments, a dough provided herein can be packaged in packaging that includes a headspace at about atmospheric pressure (e.g., 1 atm±0.2 atm, or 1 atm±0.1 atm), where the packaging material is permeable or vented to provide gas communication between the inside of the packaging and the outside of the packaging. In some embodiments, a vent in a vented package can be a pressure relief (e.g., one-way) valve that can release carbon dioxide or other gases generated by the dough within the package. Such a valve can be set to allow for an interior pressure that is about 1 atm (e.g., 13-17 psia). A vented or permeable package material can help maintain a lower carbon dioxide level in the headspace than if the packaging was not permeable or vented, so less carbon dioxide is available for absorption by a dough in the package.

In some embodiments, a dough provided herein can be packaged in a package that is pressurized (i.e., headspace having a pressure of greater than 1 atm). A pressurized package can contribute to less carbon dioxide release from a dough the package, especially if the headspace contains at least a portion of air that is an inert gas.

Other Dough Ingredients

A dough provided herein can contain additional appropriate ingredients, so long as a stable density is maintained. Ingredients suitable for including in a dough composition include egg products (e.g., whole egg or egg components), dairy products (e.g., milk, buttermilk, or other milk products or components, such as sugars, minerals or proteins, in liquid or dried form), solid fats, flavorants and/or colorants (e.g., salt, spices, extracts, or other natural or artificial flavorants and/or colorants), particulates (e.g., chocolate pieces, confections, nuts, dried fruits, and the like), emulsifiers (e.g., lecithin, mono- and diglycerides, polyglycerol esters, and the like), strengtheners (e.g., ascorbic acid), preservatives, and conditioners.

In some embodiments, a dough provided herein excludes one or more ingredients, or includes them in not more than insignificant amounts (e.g., less than 1%, or less than 0.5%, or less than 0.1%) by weight of a dough. Ingredients that can be excluded, include, for example, emulsifiers, strengtheners, conditioners, artificial colorants, or artificial flavorants.

Other Packaged Dough Product Features

A dough provided herein can be portioned and/or shaped into pieces prior to packaging. Pieces can be shaped into any suitable shape, such as a sheet or a loaf. For example, a dough can be shaped into a standard bread loaf, or mini loaves before packaging.

In another example, sheet of dough can be formed to be from about 1 mm to about 6 mm thick (e.g., from about 1.5 mm to about 5 mm thick) and shaped as desired (e.g., into a pizza crust or a dough strip that can be cooked as-is or rolled into, e.g., a cinnamon roll). In some embodiments, a dough can be flattened into a sheet on a flexible substrate (e.g., parchment paper, a slip sheet, or a polymeric analog, or the like), the dough can be sheeted and then placed on a flexible substrate before packaging. In some embodiments, a sheet of dough on a flexible substrate can be rolled up into a spirally-wound, or scroll-like configuration, before packaging.

In some embodiments, a flexible substrate suitable for use in a packaged dough product can be permeable to carbon dioxide or other gases that evolve from a packaged dough during refrigerated shelf life, which can help prevent the formation of bubbles or separation of the dough from the substrate as gas escapes the dough. An example of a commercially available flexible substrate includes, without limitation, 27# Bleached Silicone Genuine Vegetable Parchment (West Carrollton Parchment & Converting, West Carrollton, Ohio). Other suitable flexible substrates are known and commercially available.

Packages suitable for use in a packaged dough product provided herein can be any packaging suitable for refrigerated storage. Examples include tubes, pouches, boxes, and the like. Particularly suitable, are packages that include at least a portion of the exterior of the package that is a flexible polymeric (non-cardboard, non-metal) material, such as plastic tubes, polymeric chubs, polymeric sleeves, polymeric form-fill (e.g., thermoplastic) containers, polymeric pouches, and the like. In some embodiments, a package can be entirely flexible and polymeric, without requiring any exterior portions that are metal or carboard. In some embodiments, a package can act as an oxygen barrier to promote shelf life and freshness. Suitable polymeric materials for packaging include, without limitation, polyesters (e.g., PET), nylons, polyolefins (e.g., polyethylene), vinyls, polyalcohols, and the like.

In some embodiments, a package can be sized to accommodate dough when inserted into the package (e.g., sized to fit a dough piece shaped as a bread loaf, or sized to fit a scroll-like sheet), and to contain a small amount of headspace (i.e., space within the volume of the package, but not used by the dough). A useful amount of headspace can be no more than 100% (e.g., up to about 50%, up to about 40%, up to about 20%, or up to about 10%) the volume of the dough. In some embodiments, a package is sized to leave no headspace.

Methods

Methods of making a packaged dough product are provided herein. A dough provided herein can be produced by combining dough ingredients described above using standard equipment and methods. For example, a flour component, water (as liquid water and/or ice), yeast, and optional ingredients, such as oil, salt, sugar, and the like, can be combined in a spiral mixer and mixed to produce a dough. In some embodiments, mixing can be done in more than one stage. For example, a flour component, yeast, and water can be mixed, followed by the addition of other ingredients and further mixing.

Following dough production, the dough can be shaped into pieces using standard equipment and methods. For example, a dough provided herein can be directed through rollers to form a sheet, which can then be cut into rectangles or circles.

Shaped dough pieces can then be placed into the desired packaging, and the package sealed, with the exception of optional venting. In some embodiments, headspace in a package can be flushed with air containing inert gas. A flushing step can be performed by replacing regular air by displacement with air containing inert gas, or can be performed by removing regular air (e.g., by vacuum) then replacing it with air containing inert gas. In some embodiments, a package can be vacuum sealed, rather than leaving headspace. In some embodiments, a package can be pressurized with air containing inert gas. In embodiments where the package is pressurized, a rigid package is preferred to prevent deformation of the package.

In some embodiments, a dough can be rested or proofed prior to packaging. However, it is preferred that at least some proofing occurs in the package, or more preferably, most or substantially all proofing occurs in the package.

In some embodiments, a dough can be frozen prior to packaging. A frozen dough can be easier to package than a fresh dough. However, a dough provided herein can be readily packaged without freezing.

A packaged dough product can be frozen, or can remain refrigerated, during transportation for sale. A packaged dough product provided herein can have a shelf life of at least 14 days (e.g., at least 30 days, at least 45 days, or at least 60 days) following packaging at refrigerated temperatures. However, shelf life can be extended by freezing a packaged dough product provided herein.

Methods of preparing and cooking a dough are also provided. A packaged dough product provided herein, after a period of refrigerated storage in the package, can be removed from the package and cooked (e.g., baked or fried). A dough provided herein can advantageously be removed from the package and cooked directly, without requiring a resting or proofing step.

In some embodiments, where a packaged dough product is a sheet of dough rolled into a scroll configuration, the dough can be unrolled prior to cooking. In some embodiments, a dough sheet rolled with the inclusion of a flexible substrate can be unrolled so that the sheet remains on top of the flexible substrate and the dough can be cooked while on top of the substrate.

In some embodiments, a dough provided herein can be shaped and/or portioned by a consumer prior to cooking. For example, a dough provided herein can be flattened, separated into smaller pieces, or otherwise shaped or portioned as desired by the consumer.

In some embodiments, additional ingredients can be added to a packaged dough product before or after cooking. For example, a consumer can top a raw pizza dough with pizza toppings, such as a sauce and/or cheese prior to cooking. In another example, a consumer can add an icing to a dough after cooking.

A packaged dough product provided herein can be cooked to produce a cooked dough product having a volume that is from about 1.4 to about 2.2 times that volume of the raw dough. In some embodiments, a cooked dough product made from a packaged dough product provided herein can have a bake specific volume ranging from about 1.5 to about 2.5 cubic centimeters per gram.

### EXAMPLES

EXAMPLE 1, shows advantageous refrigerated storage properties and reduced carbon dioxide production of a dough based on the use of a dough formulation that contains one or more of substrate-limited yeast, reduced carbohydrase enzyme activity in the dough composition, and a reduced amount of damaged starch in the composition.

Effect of MAL− Yeast Concentration, Pre-Fermentation Step, and Percent Composite Flour in Dough on CO2 Release Rate and Bake Performance.

This Example is designed to observe how different factors affect carbon dioxide production in a dough composition during refrigeration, namely, to observe the effects of the following on carbon dioxide production: 1) the concentration of MAL− yeast, 2) the use of a pre-fermentation step to exhaust fermentable substrate sugars, and 3) the use of partial to complete replacement of a control flour with a composite flour (combination of isolated wheat starch and vital wheat gluten inherently low in amylase enzymes). The effects of these factors on bake performance were also considered.

Procedure, Materials and Methods:

Assess various combinations of flour and composite flour, over a range of MAL− yeast concentrations, to determine leavening rate upon refrigeration (+/− preferment step).

TABLE 1
Design: 5 × 3 × 2 = 30 treatments

| | | Composite | % Mal- | Yes/No |
|---|---|---|---|---|
| Treatment | Flour (%) | Flour (%) | yeast | Preferment* |
| 1 | 100 | 0 | 0.5 | No |
| 2 | 75 | 25 | 0.5 | No |
| 3 | 50 | 50 | 0.5 | No |
| 4 | 25 | 75 | 0.5 | No |
| 5 | 0 | 100 | 0.5 | No |
| 6 | 100 | 0 | 0.5 | Yes |
| 7 | 75 | 25 | 0.5 | Yes |
| 8 | 50 | 50 | 0.5 | Yes |
| 9 | 25 | 75 | 0.5 | Yes |
| 10 | 0 | 100 | 0.5 | Yes |
| 11 | 100 | 0 | 1 | No |
| 12 | 75 | 25 | 1 | No |
| 13 | 50 | 50 | 1 | No |
| 14 | 25 | 75 | 1 | No |
| 15 | 0 | 100 | 1 | No |
| 16 | 100 | 0 | 1 | Yes |
| 17 | 75 | 25 | 1 | Yes |
| 18 | 50 | 50 | 1 | Yes |
| 19 | 25 | 75 | 1 | Yes |
| 20 | 0 | 100 | 1 | Yes |
| 21 | 100 | 0 | 1.5 | No |
| 22 | 75 | 25 | 1.5 | No |
| 23 | 50 | 50 | 1.5 | No |
| 24 | 25 | 75 | 1.5 | No |
| 25 | 0 | 100 | 1.5 | No |
| 26 | 100 | 0 | 1.5 | Yes |
| 27 | 75 | 25 | 1.5 | Yes |
| 28 | 50 | 50 | 1.5 | Yes |
| 29 | 25 | 75 | 1.5 | Yes |
| 30 | 0 | 100 | 1.5 | Yes |

*Dough held at ambient for ~20 hours prior to final shaping and freezing.

TABLE 2
0.5% Mal-Yeast (Treatments 1-10)
Batch gm 4000

| | | | 75% Flour- | | 50% Flour- | | T4/T9 | | T5/T10 | |
|---|---|---|---|---|---|---|---|---|---|---|
| | 100% | | 25% Composite | | 50% Composite | | 25% Flour- | | 25% Flour- | |
| | Flour | | Flour | | Flour | | 75% Composite | | 75% Composite | |
| Ingredient | % | Grams | % | Grams | % | Grams | % | Grams | % | Grams |
| Cycle 1 | | | | | | | | | | |
| FLOUR, HARD WINTER, BL ENF | 52.955 | 2118.2 | 39.841 | 1593.64 | 26.4775 | 1059.1 | 13.11375 | 524.55 | 0 | 0 |
| HRW LE Flour | 0 | 0 | 0 | 0 | 0 | 0 | | 0 | 0 | 0 |
| WATER (~32° F.) | 37.044 | 1481.76 | 37.306 | 1492.24 | 37.5655 | 1502.62 | 37.81825 | 1512.73 | 38.233 | 1529.32 |
| OLIVE OIL | 2 | 80 | 2 | 80 | 2 | 80 | 2 | 80 | 1.962 | 78.48 |
| VITAL WHEAT GLUTEN | 2 | 80 | 3.285 | 131.4 | 4.571 | 182.84 | 5.865 | 234.6 | 7.141 | 285.64 |
| WHEAT STARCH | | 0 | 11.567 | 462.68 | 23.385 | 935.4 | 35.202 | 1408.08 | 46.769 | 1870.76 |
| POTATO STARCH | 4 | 160 | 4 | 160 | 4 | 160 | 4 | 160 | 3.923 | 156.92 |
| MAL-YEAST dry | 0.5 | 20 | 0.5 | 20 | 0.5 | 20 | 0.5 | 20 | 0.5 | 20 |
| SAF Instant yeast | 0 | 0 | 0 | 0 | 0 | 0 | 0 | 0 | 0 | 0 |
| GLUCOSE OXIDASE | 0.001 | 0.04 | 0.001 | 0.04 | 0.001 | 0.04 | 0.001 | 0.04 | 0.001 | 0.04 |
| Cycle 2 | | | | | | | | | | |
| SODIUM CHLORIDE | 1.5 | 60 | 1.5 | 60 | 1.5 | 60 | 1.5 | 60 | 1.471 | 58.84 |
| GRANULATED SUGAR | 0 | 0 | 0 | 0 | 0 | 0 | 0 | 0 | 0 | 0 |
| DEXTROSE | 0 | 0 | 0 | 0 | 0 | 0 | 0 | 0 | 0 | 0 |
| TOTAL | 100 | 4000 | 100 | 4000 | 100 | 4000 | 100 | 4000 | 100 | 4000 |
| | | | | | | | 4000 | | | |

TABLE 3
1% Mal-Yeast (Treatments 11-20)

| | | | T12/T17 | | T13/T18 | | T14/T19 | | | |
|---|---|---|---|---|---|---|---|---|---|---|
| | T11/T16 | | 75% Flour- | | 50% Flour- | | 25% Flour- | | T15/T20 | |
| | 100% | | 25% Composite | | 50% Composite | | 75% Composite | | 100% | |
| | Flour | | Flour | | Flour | | Flour | | composite | |
| Ingredient | % | Grams | % | Grams | % | Grams | % | Grams | % | Grams |
| Cycle 1 | | | | | | | | | | |
| FLOUR, HARD WINTER, BL ENF | 52.455 | 2098.2 | 39.341 | 1573.64 | 26.2275 | 1049.1 | 13.11375 | 524.55 | 0 | 0 |
| HRW LE Flour | 0 | 0 | 0 | 0 | 0 | 0 | | 0 | 0 | 0 |
| WATER (~32° F.) | 37.044 | 1481.76 | 37.306 | 1492.24 | 37.5655 | 1502.62 | 37.81825 | 1512.73 | 38.233 | 1529.32 |
| OLIVE OIL | 2 | 80 | 2 | 80 | 2 | 80 | 2 | 80 | 1.962 | 78.48 |
| VITAL WHEAT GLUTEN | 2 | 80 | 3.285 | 131.4 | 4.571 | 182.84 | 5.865 | 234.6 | 7.141 | 285.64 |
| WHEAT STARCH | | 0 | 11.567 | 462.68 | 23.135 | 925.4 | 34.702 | 1388.08 | 46.269 | 1850.76 |
| POTATO STARCH | 4 | 160 | 4 | 160 | 4 | 160 | 4 | 160 | 3.923 | 156.92 |
| MAL-YEAST dry | 1 | 40 | 1 | 40 | 1 | 40 | 1 | 40 | 1 | 40 |
| SAF Instant yeast | 0 | 0 | 0 | 0 | 0 | 0 | 0 | 0 | 0 | 0 |
| GLUCOSE OXIDASE | 0.001 | 0.04 | 0.001 | 0.04 | 0.001 | 0.04 | 0.001 | 0.04 | 0.001 | 0.04 |
| Cycle 2 | | | | | | | | | | |
| SODIUM CHLORIDE | 1.5 | 60 | 1.5 | 60 | 1.5 | 60 | 1.5 | 60 | 1.471 | 58.84 |
| GRANULATED SUGAR | 0 | 0 | 0 | 0 | 0 | 0 | 0 | 0 | 0 | 0 |
| DEXTROSE | 0 | 0 | 0 | 0 | 0 | 0 | 0 | 0 | 0 | 0 |
| TOTAL | 100 | 4000 | 100 | 4000 | 100 | 4000 | 100 | 4000 | 100 | 4000 |
| | | | | | | | 4000 | | | |

TABLE 4
1.5% Mal-Yeast (Treatments 21-30)

| | | | T22/T27 | | T23/T28 | | | | | |
|---|---|---|---|---|---|---|---|---|---|---|
| | T21/T26 | | 75% Flour- | | 50% Flour- | | T24/T29 | | T25/T30 | |
| | 100% | | 25% Composite | | 50% Composite | | 25% Flour- | | 100% | |
| | Flour | | Flour | | Flour | | 75% Composite | | composite | |
| Ingredient | % | Grams | % | Grams | % | Grams | % | Grams | % | Grams |
| Cycle 1 | | | | | | | | | | |
| FLOUR, HARD WINTER, BL ENF | 51.955 | 2078.2 | 38.841 | 1553.64 | 25.9775 | 1039.1 | 13.11375 | 524.55 | 0 | 0 |
| HRW LE Flour | 0 | 0 | 0 | 0 | 0 | 0 | | 0 | 0 | 0 |
| WATER (~32° F.) | 37.044 | 1481.76 | 37.306 | 1492.24 | 37.5655 | 1502.62 | 37.81825 | 1512.73 | 38.233 | 1529.32 |
| OLIVE OIL | 2 | 80 | 2 | 80 | 2 | 80 | 2 | 80 | 1.962 | 78.48 |
| VITAL WHEAT GLUTEN | 2 | 80 | 3.285 | 131.4 | 4.571 | 182.84 | 5.865 | 234.6 | 7.141 | 285.64 |
| WHEAT STARCH | | 0 | 11.567 | 462.68 | 22.885 | 915.4 | 34.202 | 1368.08 | 45.769 | 1830.76 |
| POTATO STARCH | 4 | 160 | 4 | 160 | 4 | 160 | 4 | 160 | 3.923 | 156.92 |
| MAL-YEAST dry | 1.5 | 60 | 1.5 | 60 | 1.5 | 60 | 1.5 | 60 | 1.5 | 60 |
| SAF Instant yeast | 0 | 0 | 0 | 0 | 0 | 0 | 0 | 0 | 0 | 0 |
| GLUCOSE OXIDASE | 0.001 | 0.04 | 0.001 | 0.04 | 0.001 | 0.04 | 0.001 | 0.04 | 0.001 | 0.04 |
| Cycle 2 | | | | | | | | | | |
| SODIUM CHLORIDE | 1.5 | 60 | 1.5 | 60 | 1.5 | 60 | 1.5 | 60 | 1.471 | 58.84 |
| GRANULATED SUGAR | 0 | 0 | 0 | 0 | 0 | 0 | 0 | 0 | 0 | 0 |
| DEXTROSE | 0 | 0 | 0 | 0 | 0 | 0 | 0 | 0 | 0 | 0 |
| TOTAL | 100.00 | 4000.00 | 100.00 | 4000.00 | 100.00 | 4000.00 | 100.00 | 4000.00 | 100.00 | 4000.00 |

Mixing (all Treatments)

Equipment: Spiral mixer (L'art du Melange)
1) Add glucose oxidase to iced water (use strainer to keep ice out of formula water)
2) Add (iced) water plus enzyme to mixing bowl
3) Add oil to water in mixing bowl
4) Add combined dry first stage ingredients to water/oil in mixing bowl
5) Mix slow for 30 sec. and fast for 5 minutes
6) Add 2nd stage dry ingredients
7) Mix slow for 30 sec. and fast for 4 minutes.

Straight Dough Process (Treatments—1, 2, 3, 4, 5, 11, 12, 13, 14, 15, 21, 22, 23, 24, 25)
1) Divided dough into 200 gram pieces and sheeted into oval/round shape using a rolling pin (final thickness ˜4-5 mm)
2) Placed sheeted pieces onto parchment paper (8″×12″) and rolled into tight rolled-cylinder format.
3) Placed rolled pieces onto trays and then into a blast freezer set at −29° F. 4) Removed samples from blast freezer after ˜1-2 hours and stored at −10° F. until packaging step.

Dough Measurements Post-Mixing
Placed duplicate 25 gm samples into Risograph sample jars and started collecting gas evolution data (set to collect at 10 min. intervals). The samples were held at ambient temperature ˜70° F.). The Risograph is an electronic instrument that measures gas generated by fermenting dough or chemical leavening; these are commercially sold by the National Division of TMCO, Lincoln, Nebr., U.S.A. The instrument rapidly and accurately determines the amount (e.g., in milliliters) of CO2 per minute evolved (rate) from a sample, as well as the cumulative gas released.
Measured dough water activity (aw) and pH.

Preferment Process (Treatments—6, 7, 8, 9, 10, 16, 17, 18, 19, 20, 26, 27, 28, 29, 30)
1) Divided dough into 200 gm pieces and rolled into ball shape.
2) Placed rounded dough pieces onto parchment lined baking sheets and covered with a plastic bag (placed 4 inverted cups onto the tray surface to prevent the dough from sticking to the bag upon expansion and taped bag end closed but not airtight).
3) Allowed dough to rest at room temperature (70° F.) overnight.
4) Sheeted (and degassed) the expanded dough to 4-5 mm thickness and prepared samples for freezing as described in steps 2-4 above for the straight dough process.

Packaging (FFS—Form Fill Seal, Unvented Package)
Dough samples packaged frozen to prevent collapse of dough structure upon vacuum/flush process.
Machine: MultiVac 540
Pouch cavity dimensions: width 2.5625″, Depth 2.5″, Length 14.3125″
Film (Curwood/Bemis)
Formable cavity material—Curlon Grade 9531-AA
Lid Stock—Curlam Grade 18334-K
Flushed with 60% N2/40% CO2 gas
   Packages labeled, weighed, and initial volumes recorded (volumetric displacement process) prior to being stored at 40° F.

Analysis

Dough—(Measurements Taken Immediately after Final Mixing Step):

Aw, pH, and Risograph gas evolution for duplicate 25 gm pieces for T1-T15. Data collected every 10 minutes at ambient ≣70° F.

Package—(Days 0, 5, and 10):

Package volume change (volumetric displacement method)

Product Evaluation—(Measured at Day 9, Day 20, and Day 30 after Placing Dough in Package)

Dough:

Ease of un-rolling (qualitative assessment), general observations.

Dough specific volume.

Dough height (3 measurements across pad).

After baking (425° F. for 13 min. in Reel oven):
Bake height (3 measurements across crust)
Minolta L*, a*, b* color measurement
Photograph
Taste (qualitative assessment)

Results:

Out Gassing Rate

For each MAL− yeast concentration evaluated; plotted slope of linear change in package volume for pre-fermented and non-fermented sample sets vs. storage time as a function of the flour (control HRW) used in formula.

Observations:

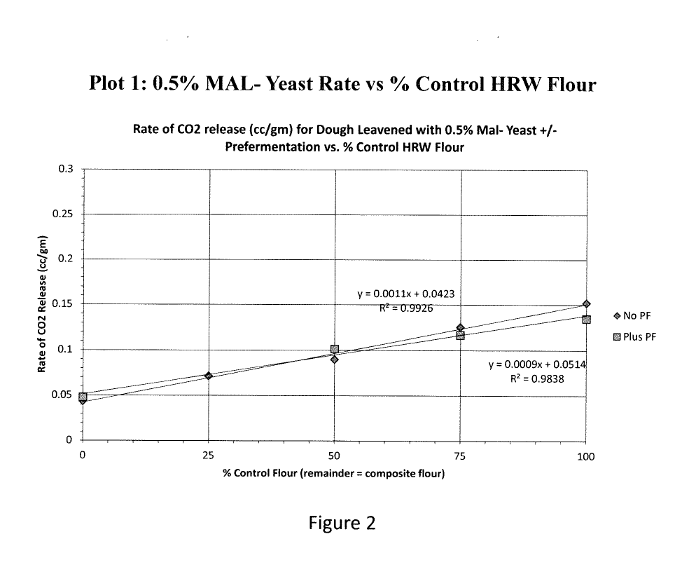

Outgassing rate is a positive linear function of the percent control flour present in the dough. Conversely, as the percent of composite flour increases, outgassing declines in a linear fashion. One can infer from these observations that the flour is providing additional substrate to the yeast by either i) Increasing the concentration of hydrolytic amylase enzyme present in the dough, by providing damaged starch for the amylases to convert into fermentable sugars, or both. At the low MAL− yeast concentration of 0.5%, there is little difference in gas release rate between the non-fermented and fermented sample sets. The pre-fermentation (PF) step with 0.5% MAL− yeast did not exhaust the fermentable substrate sugar in the dough. See FIG. 2 (Plot 1: 0.5% MAL− Yeast Rate vs % Control HRW Flour).

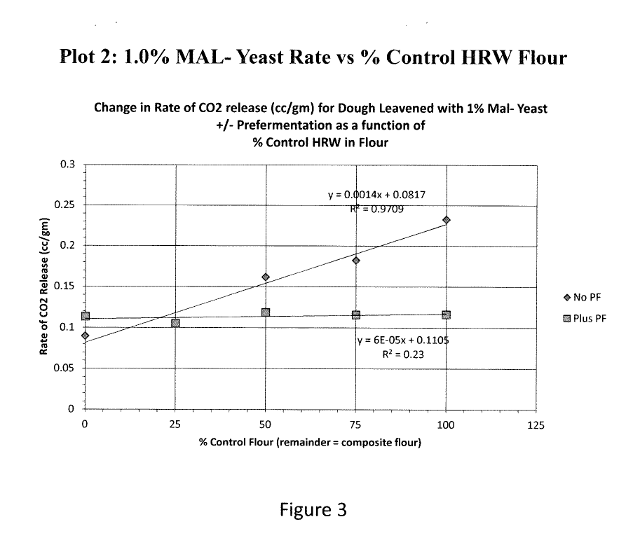

Looking at FIG. 3 (Plot 2: 1.0% MAL-Yeast Rate vs % Control HRW Flour), at 1% MAL− yeast, a positive linear increase in outgassing rate is observed as the amount of control HRW flour in the “no pre-ferment” sample set increases (similar to the 0.5% MAL− yeast results described earlier). Unlike the 0.5% MAL− results, however, when the 1% MAL− yeast sample set was subjected to a pre-fermentation step, the CO2 release rate did not increase, but rather remained fairly low, constant, and independent of flour composition. One can hypothesize that the observed low baseline CO2 release rate in the pre-fermented samples is the result of the continued hydrolysis of starch oligosaccharides over storage time. Lastly, the observation that the pre-fermented CO2 release rate remains fairly low and consistent regardless of the flour composition indicates that a majority of the fermentable substrate is exhausted during the pre-ferment step.

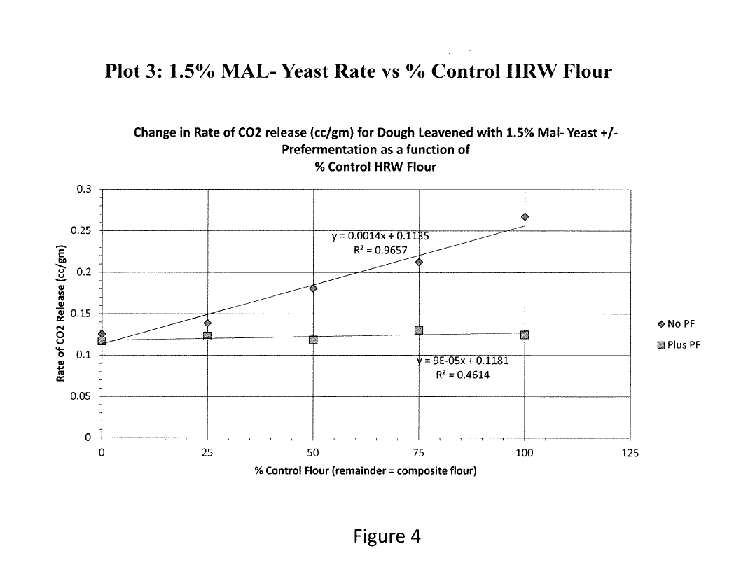

Looking now at FIG. 4 (Plot 3: 1.5% MAL− Yeast Rate vs % Control HRW Flour), at 1.5% MAL− yeast, a positive linear increase in out gassing rate is observed as the amount of flour increases in the “no pre-ferment” sample set (similar to previous results at 0.5 and 1% MAL− yeast). As was observed with the 1.0% MAL− yeast results, when the 1.5% MAL− yeast sample set was subjected to a pre-fermentation step, the CO2 release rate remained constant and independent of flour composition. One can hypothesize that the observed low baseline CO2 release rate in the pre-fermented samples is the result of the hydrolysis of starch oligosaccharides over time (see earlier discussion). Lastly, the observation that the pre-fermented CO2 release rate remains fairly low and consistent regardless of the flour composition indicates that a majority of the fermentable substrate is exhausted during the pre-ferment step.

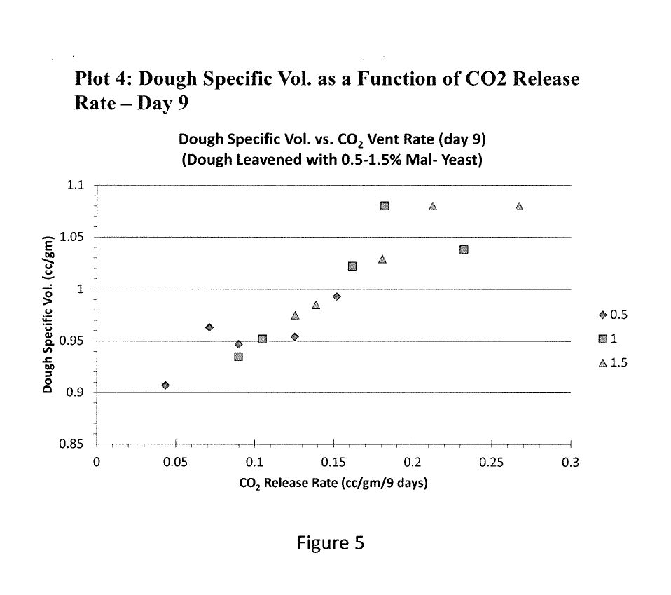

Referring now to FIG. 5 (Plot 4: Dough Specific Vol. as a Function of CO2 Release Rate—Day 9): After 9 days storage, a linear increase in dough specific volume is observed with increasing CO2 release rates. The relationship is independent of the means by which CO2 release rate was achieved. That is to say, regardless of various combinations of % MAL− yeast and % control flour, comparable CO2 release rates resulted in comparable dough specific volumes.

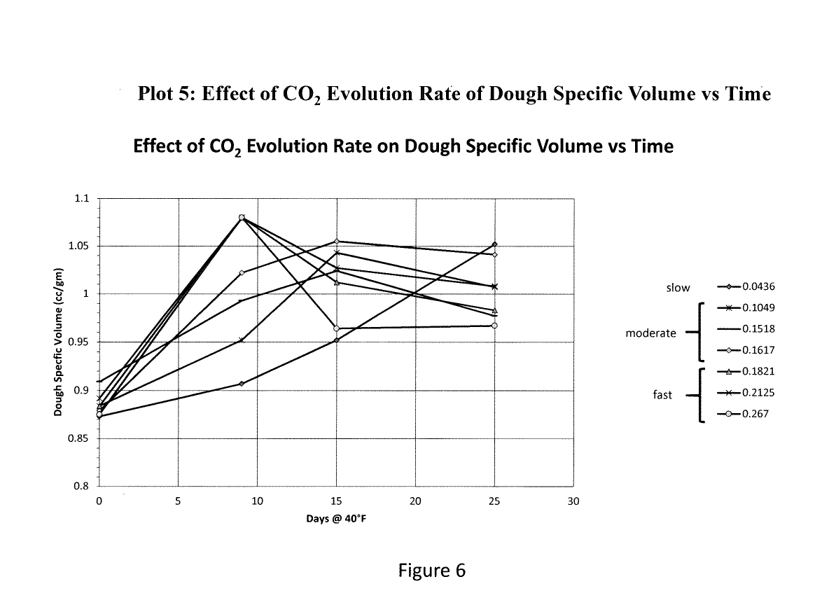

Referring to FIG. 6 (Plot 5: Effect of CO2 Evolution Rate of Dough Specific Volume vs Time): A sampling of CO2 evolution rates (cc CO2/gm/day at 40° F.) shows three distinct dough specific volume profiles vs storage time (not all treatments shown for ease of comparison). At higher CO2 evolution rates (>0.1821 cc/gm/day) (i.e., 0.1821, 0.2125, 0.267 cc/gm/day), a rapid increase in specific volume over the initial 10 days of storage to >1.05 cc/gin is observed, followed by a decline to 0.96-1.02 between days 10 and 15. For CO2 evolution rates ranging from 0.1049-0.1617 cc/gm/day, one observes a more moderate increase in dough specific volume through day 15 followed by a plateau/stabilization in dough specific volume ranging from 0.96-1.04 cc/gm between days 15 and 25. At the lowest CO2 evolution rates observed (0.0436 cc/gm/day), one observes a more linear and less rapid increase in dough specific volume over time, with an end specific volume of 1.05 cc/gm. Generally speaking, the less rapid the CO2 evolution rate, the less likely dough specific volumes will decline upon reaching a maximum specific volume value.

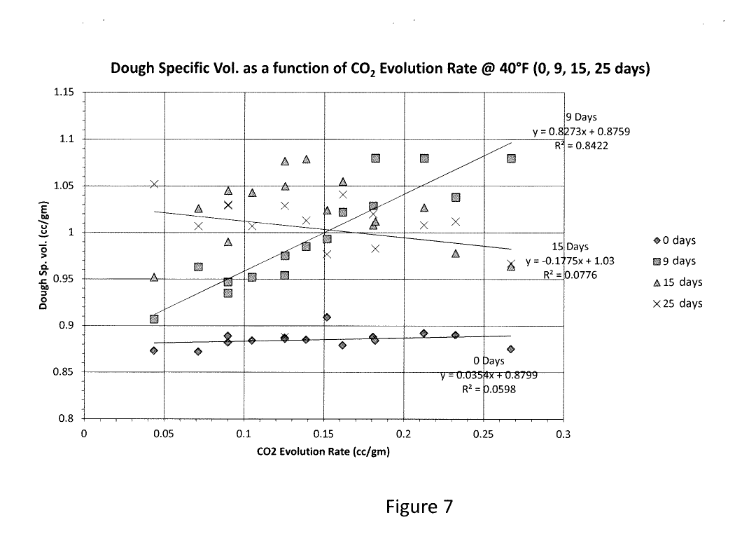

Referring to FIG. 7 (Plot 6: Dough Specific Volume vs. CO2 Release Rate at 0-25 days): At time=0 all dough densities are ˜comparable (no opportunity of out gassing as the dough is frozen prior to packaging). After 9 days, a positive linear relationship is observed between dough specific volume and CO2 evolution rate (see plot 6 also). At 15 days, peak in dough specific volume is observed followed by a decline, with increasing evolution rate (dough structure can't maintain expanded volume at higher CO2 evolution rates >0.14 cc/gm). At 25 days, a steady specific volume is reached at ˜1 cc/gm across all CO2 evolution rates (expanded dough is no longer capable of increase in volume).

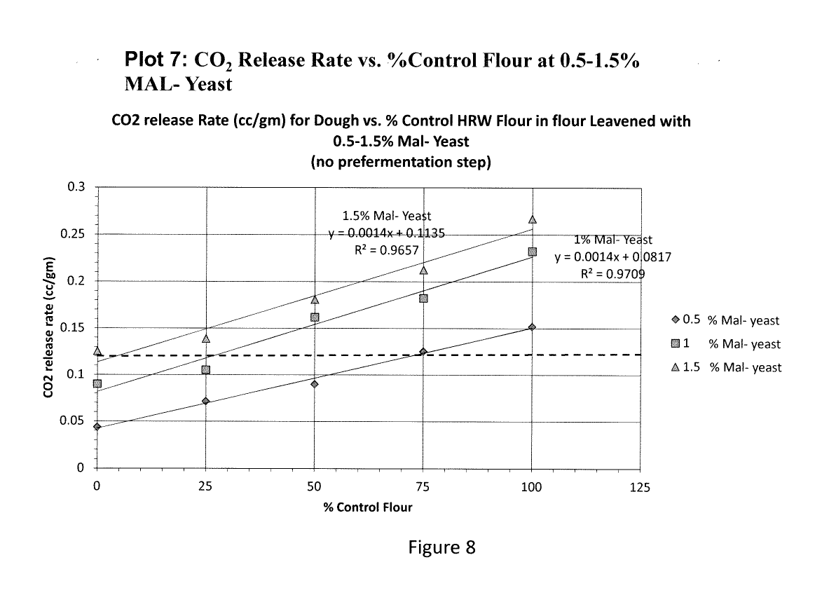

Referring to FIG. 8 (Plot 7: CO2 Release Rate vs. % Control Flour at 0.5-1.5% MAL− Yeast): Combining the no preferment CO2 release rates curves from plots 1-3, and the CO2 release rate area (below the dashed line) that results in minimal/reduced dough structure collapse, identifies MAL− yeast concentration and flour combinations that are highly desirable for stable refrigerated dough structure. Based on this plot and other observations described earlier, 0.5% MAL− yeast concentration provides the highly desirable result over a range of control HRW flour compositions (0-75% control flour/100-25% composite flour) resulting in CO2 evolution rates <0.12-0.13 cc/gm associated more stable dough specific volumes. 1% and 1.5% MAL− yeast concentrations can provide desired results over reduced ranges of flour per composite flour.

Summary:

A pre-fermentation step of >20 hours at ambient temperatures, will exhaust a majority of the fermentable substrate that is generated in a dough by the enzymatic hydrolysis of damaged starch, during preparation. As a result, CO2 gas evolution rate upon refrigeration is relatively flat; the pre-fermented dough systems 1) can outgas very little over storage time, and 2) expand only slightly upon baking due to a lack in gas holding capacity and collapse of nucleated structure.

When no pre-fermentation step is performed, there is a positive and linear relationship between MAL− yeast concentration and CO2 release rate (more yeast=greater CO2 evolution rate). Moreover, for a given MAL− yeast concentration, outgassing rate is a positive linear function of the amount of control HRW flour (on a percentage basis) present in the dough, relative to composite flour. Conversely, as the amount of composite flour (concentrated protein ingredient and concentrated starch ingredients, replacing an amount of the flour) increases, replacing a portion of the flour, outgassing declines in a linear fashion. The flour appears to be providing additional substrate to the yeast by either i) increasing the concentration of hydrolytic amylase enzyme present in the dough, or ii) providing more damaged starch for the amylases to convert into fermentable sugars.

It appears that, while pre-fermentation provides for a stable density and volume in the package, the end product is not able to perform well during cooking. The data for samples that were not pre-fermented provides insight into the variables that can be controlled to maintain both stable density in the package and performance of the product in a non pre-fermented dough.

EXAMPLE 2, shows advantageous refrigerated storage properties and stable density of dough compositions provided herein.

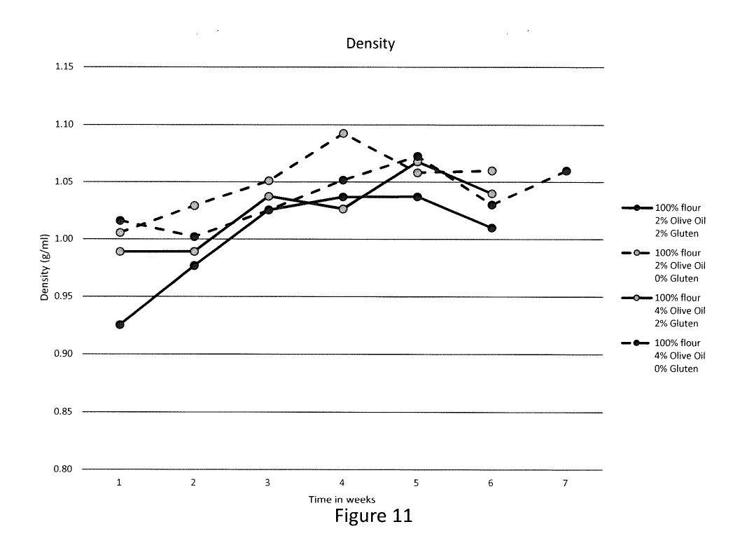

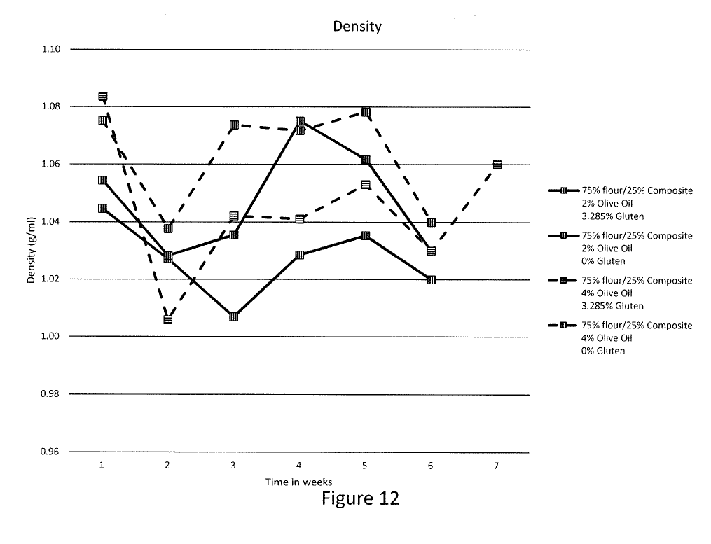

Referring to FIGS. 9-12, sample doughs were prepared and packaged similarly, without composite flour (100% flour) or with 25% composite flour. In addition, flour components either contained either no added gluten, with any added composite flour being only isolated starch (0% gluten), or added gluten, with any added composite flour containing isolated starch plus vital wheat gluten. Finally, either 2% olive oil or 4% olive oil was included in the dough. As can be observed, samples that contained composite flour generally had a higher density at early timepoints than those with 100% flour, and a more stable density over time than the 100% flour samples. However, samples with 100% flour were more stable where no additional gluten was added (see, FIG. 9), and/or 4% oil were stable and between 0.95 and 1.14 g/ml in density over at least 6 weeks (see, FIG. 11). The addition of gluten generally decreased density and increased CO2 release (see, FIGS. 9-12), while higher oil content increased density (compare 2% olive oil to 4% olive oil in FIGS. 11 and 12). Thus, it appears that gluten and oil content can be balanced to support a stable density over shelf life, even in a dough that included no composite flour.

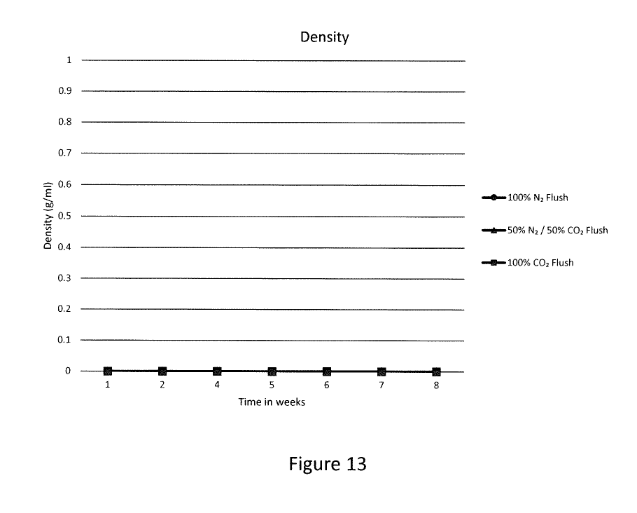

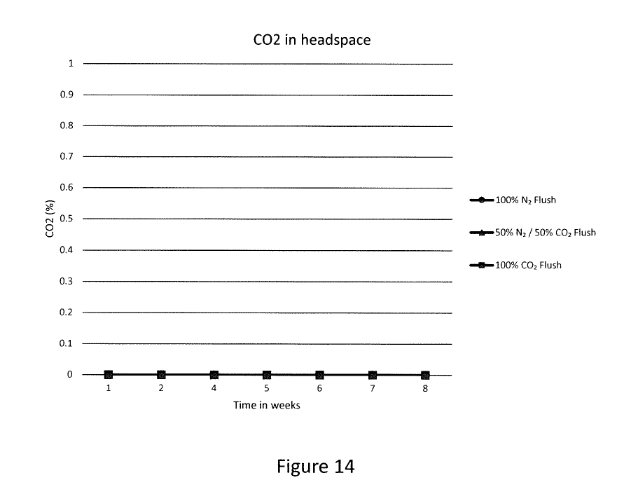

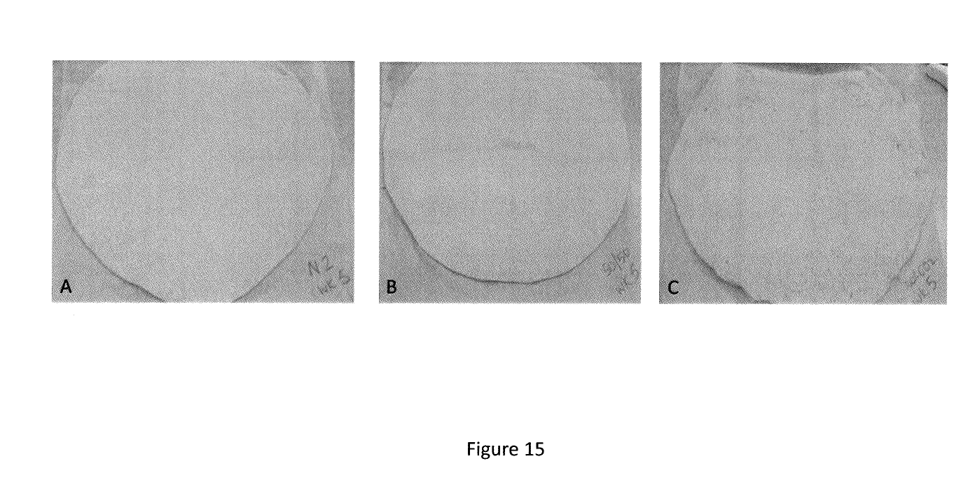

Referring to FIGS. 13-15, sample doughs were prepared and packaged similarly, with differing headspace air compositions (100% CO2, 50% CO2/50% N2, or 100% N2). As can be seen in FIG. 13, increasing CO2 concentrations in the headspace reduced overall density. Without being bound to theory, it is believed that CO2 in the headspace can be absorbed by the dough and contribute to a lower density. As can be seen in FIG. 14, while the packaged dough with the 100% CO2 headspace flush remained steady at 100%, the amount of CO2 in the headspace in the N2 flushed and 50% N2/50% CO2 flush increased over time at a similar rate as CO2 was released from the dough. Even at 5 weeks, the sample flushed with 100% N2 had less than 50% CO2 in the headspace. At about 55% to 60% CO2 in the headspace, the dough became more sticky, which can make it more difficult to handle. This is more noticeable in dough sheets that are rolled up in a scroll like configuration since they are more likely to stick while unrolling, leading to damage to the dough (see, FIG. 15). FIGS. 15A, 15B, and 15C show the effects of these headspaces on an unrolled dough. FIG. 15A shows the unrolled dough from a packaged dough product having a 100 percent N2 flush, after 5 weeks refrigerated storage, unrolled with no damage. FIG. 15B shows the unrolled dough from a packaged dough product having a 50/50 N2/CO2 flush, after 5 weeks refrigerated storage, with some amount of damage to the dough surface due to being unrolled. FIG. 15C shows the unrolled dough from a packaged dough product having a 100 percent CO2 flush, after 5 weeks refrigerated storage, with substantial damage to the dough surface upon being unrolled. This is less of a problem in dough in a loaf format, which needs less handling prior to baking.

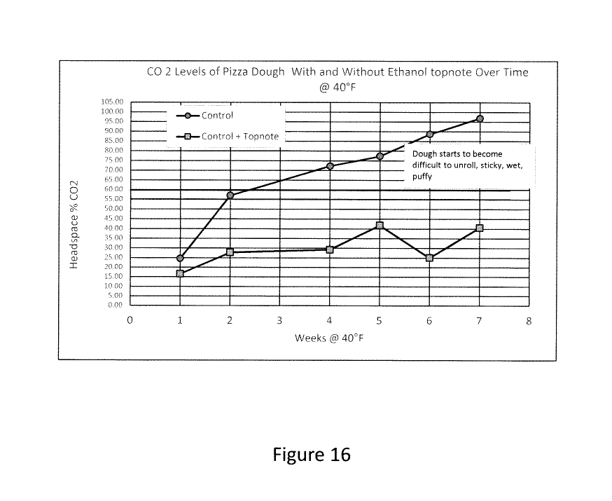

Referring to FIG. 16, sample doughs were prepared and packaged similarly, with and without ethanol. The control formula does not contain ethanol and the test formula contains ethanol (sold under the trade name “TOPNOTE”). Packaged dough products were prepared with comparable dough compositions and comparable packaging, with headspace, with and without ethanol. The samples that contain ethanol have lower concentrations of CO2 in the headspace when measured during refrigerated storage, are less fermented, have a smoother surface, and are easier to unroll (from a roll of dough and parchment) over time. Levels of ethanol in the doughs were tested at range from 0, 1.5 and 2.0% of the total weight of the dough composition.

Table 5, below, shows some suitable ranges of ingredients for a dough provided herein.

TABLE 5
Formula Ranges

| INGREDIENT | IDEAL | LOW | HIGH |
|---|---|---|---|
| Flour | 44 | 34 | 60 |
| Water | 33 | 22 | 44 |
| Oil | 2 to 4 | 0 | 6 |
| Protein | 3 to 4 | 0 | 5 |
| Ethanol | 1.5 | 0 | 2 |
| Potato Starch | 4 to 6 | 0 | 12 |
| Non-Potato Starch | 4 to 6 | 0 | 12 |
| Xanthan Gum | 0.15 | 0 | 0.25 |
| Yeast | 0.5 | 0.25 | 1.5 |
| Glucose Oxidase | 0.001 | 0 | 0.002 |
| Salt | 1.5 | 0.5 | 2 |
| Granulated Sugar | 2 | 0 | 6 |

1. A packaged dough product, comprising:
a yeast-leavened raw dough enclosed in a package, the dough including 0.1% to 5% by weight Mal− yeast, and having an apparent viscosity of 1000 to about 2000 Brabender Units (BU) and a stable density of no less than 0.950 g/cc to no more than 1.14 g/cc at refrigeration temperatures, the packaged dough product additionally having at least one of:
a. a flour component in the dough that includes a composite flour in an amount of from about 10% to about 50% by weight of the flour component, the composite flour including at least 95% isolated starch;
b. an oil content in the dough of about 2% to about 6% by weight of the dough; and
c. gas in a headspace in the package including at least 50% inert gas.

2-4. (canceled)

5. The packaged dough product of claim 1, wherein the isolated starch comprises from 30% to 70% isolated potato starch.

6. The packaged dough product of claim 1, wherein the composite flour includes a protein concentrate or protein isolate.

7. The packaged dough product of claim 1, wherein the flour component has an amylase activity of 36 Beta amyl-3 U/g of the flour component or less.

8. The packaged dough product of claim 1, wherein the flour component has a starch content that contains less than 5% damaged starch by weight of the starch content.

9. The packaged dough product of claim 1, wherein the dough further comprises an ethanol ingredient in an amount of about 0.8% to about 1.4% by weight of the dough.

10. The packaged dough product of claim 1, wherein the package is non-pressurized.

11. The packaged dough product of claim 1, wherein the package is vented.

12. The packaged dough product of claim 1, wherein the headspace gas is essentially all inert gas.

13. The packaged dough product of claim 1, wherein the packaged dough product has a shelf life at refrigerated temperatures of at least 30 days.

14. The packaged dough product of claim 1, wherein the density is stable over at least 30 days at refrigeration temperatures.

15. (canceled)

16. The packaged dough product of claim 1, wherein the dough requires no proofing time between removal from the package and before cooking.

17-20. (canceled)

21. A method of making a packaged dough product, the method comprising:
d. combining dough ingredients to make a raw dough including 0.1% to 5% by weight Mal− yeast and having an apparent viscosity of 1000 to about 2000 Brabender Units (BU), the raw dough having at least one of:
i. a flour component that includes a composite flour in an amount of from about 10% to about 50% by weight of the flour component, the composite flour including at least 95% isolated starch; and
ii. an oil content of about 2% to about 6% by weight of the raw dough;
e. shaping the raw dough into pieces; and
packaging the shaped raw dough pieces into a package to produce the packaged dough product, the raw dough pieces having a stable density of no less than 0.950 glee to no more than 1.14 g/cc at refrigeration temperatures.

22-26. (canceled)

27. The method of claim 21, further comprising the step of replacing air in a headspace of the package with at least 50% inert gas.

28. (canceled)

29. The method of claim 21, wherein the shaped raw dough pieces proof in the package.

30. (canceled)

31. The method of claim 21, wherein the isolated starch comprises from 30% to 70% isolated potato starch.

32. The method of claim 21, wherein the composite flour includes a protein concentrate or protein isolate.

33. The method of claim 21, wherein the flour component has an amylase activity of 36 Beta amyl-3 U/g of the flour component or less.

34. The method of claim 21, wherein the flour component has a starch content that contains less than 5% damaged starch by weight of the starch content.

35. The method of claim 21, wherein the raw dough further comprises an ethanol ingredient in an amount of about 0.8% to about 1.4% by weight of the raw dough.

36. The method of claim 21, wherein the package is non-pressurized.

37. The method of claim 21, wherein the package is vented.

38. The method of claim 21, wherein the package has a headspace that has essentially all inert gas.

39. The method of claim 21, wherein the packaged dough product has a shelf life at refrigerated temperatures of at least 30 days.

40. The method of claim 21, wherein the density is stable over at least 30 days at refrigeration temperatures.

41. (canceled)

42. The method of claim 21, wherein the dough requires no proofing time between removal from the package and before cooking.

43-66. (canceled)
